(19) United States
(12) Patent Application Publication
(10) Pub. No.: US 2006/0218103 A1
(43) Pub. Date: Sep. 28, 2006

(54) Method and system for optimizing waste media disposal

(76) Inventor: Charles S. Williams, Golden, CO (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 11/322,618

(22) Filed: Dec. 30, 2005

Related U.S. Application Data
(60) Provisional application No. 60/641,180, filed on Jan. 3, 2005.

(51) Int. Cl. G06F 17/00

(52) U.S. Cl. 705/400

(57) ABSTRACT

A method and apparatus for cleaning and disposing of radioactive or contaminated media, as well as assessing a cost and profit structure for performing such cleaning and disposal. The embodiment may calculate profit and loss for a filtering plant, taking into account various factors such as the disposal site chosen, cost to erect the plant, debt taken on to finance the plant, length of the contract to filter the contaminants, and so forth.

### CROSS-REFERENCE TO RELATED APPLICATIONS

This application claims priority to U.S. Provisional Patent Application No. 60/641,180 titled “Method and System For Optimizing Waste Media Disposal,” filed Jan. 3, 2005, which is hereby incorporated by reference herein.

### BACKGROUND OF THE INVENTION

a. Field of the Invention

This invention relates generally to disposal of waste or radioactive contaminated media, and more specifically to methods and apparatuses for assessing a cost structure for disposing of the same.

b. Description of Related Art

Radioactive material, such as uranium, strontium, cesium, radium, and so forth, has become increasingly common with various technological developments. For example, radioactive material is likely best-known for its use as a power source in nuclear reactors. Less well-known, but equally vital, uses of radioactive material include medical applications, industrial processing, and so forth. Further, radioactive material occurs naturally, and is often interspersed in common earth.

No matter the application, spent radioactive material poses certain problems; the same is true of, for example, filtering agents used to filter material that may have contaminated groundwater or earth from the water itself. Due to the potential health risks posed by radioactive material (such as these spent filtering agents), it cannot simply be gathered and placed in most municipal disposal locations. Instead, certain certified locations may accept and safely store such material. These disposal sites are relatively rare and are often geographically separated by significant distances. For example, Grandview is located in Utah, while Hanford is located in Washington state. Depending on one's geographic location, transporting radioactive material to one site over another may prove more costly.

Further, each disposal site may charge additional fees for disposal or acceptance of radioactive material. Continuing the example, Hanford may charge a labor and bagging fee to accept material, while Grandview may not. Thus, in addition to the geographic considerations, one must factor additional end fees to determine acceptable disposal sites.

Additionally, the fees charged by disposal sites may vary greatly. Fees may vary within a site (for example, Hanford may charge $5/pound to dispose of radioactive material having 1000 picocuries per liter, and $10/pound for materials having more than 1000 picocuries per liter. Accordingly, and especially when a shipment may contain contaminants having varying radioactivity levels, calculating disposal costs may be difficult.

Further, determining costs associated with constructing a plant to decontaminate a well or other supply of radioactive/contaminated liquid (or, in some cases, solids) may be difficult and time-consuming. Plant construction depends on a number of variables, and accordingly forecasting such costs requires not only determining the variables accurately, but also spending the time to perform a number of calculations. This is even more true when attempting to estimate the profitability of such a plant. Accordingly, an improved method and apparatus for determining plant costs and profitability would be useful, as would an improved method and apparatus for estimating disposal costs associated with a filtering agent used to clean a contaminated liquid.

### BRIEF SUMMARY OF THE INVENTION

Generally, one embodiment takes the form of a method and apparatus for disposing of radioactive or contaminated media, as well as assessing a cost structure for performing such disposal. The embodiment may assist in determining which of a variety of disposal sites to which the media should be shipped. By determining the relative cost of shipping to and storage at each site, the costs may be minimized and profits maximized. The embodiment may take a variety of factors into account, including distance to ship to various disposal sites, the cost of opening new disposal wells at each site, varying cost structures at each site (i.e., certain sites charging more to accept certain media), capital contributions and other up-front cost required, and so forth.

The embodiment may also determine a cost to construct a plant servicing one or more wells filled with contaminated liquid. The cost of the plant (or plants) may be analyzed in a variety of manners. For example, the embodiment may determine a percentage of the plant to be financed by debt and a percentage to be financed by equity, along with the cost of construction. This information may be used to amortize the construction debt across a period of years, determine an internal rate of return, monthly and/or annual financial schedules (including revenue, operating expenses, and expenses associated with changing out a filtering agent for the contaminated liquid), capital asset acquisitions and amortizations, cash flows, and so forth.

### BRIEF DESCRIPTION OF THE DRAWINGS

FIG. 1 depicts a first screenshot of the present embodiment, showing a data input screen.

FIG. 2 depicts a second screenshot of the present embodiment, showing the data input screen of FIG. 1 with the “Location and Timing” subscreen expanded.

FIG. 3 depicts a third screenshot of the present embodiment, showing the data input screen of FIG. 1 with the “Well Characteristics” subscreen expanded.

FIG. 4 depicts a fourth screenshot of the present embodiment, showing the data input screen of FIG. 1 with the “Zeolite Properties” subscreen expanded.

FIG. 5 depicts a fifth screenshot of the present embodiment, showing the data input screen of FIG. 1 with the “Revenue Assumptions” subscreen expanded.

FIG. 6 depicts a sixth screenshot of the present embodiment, showing the data input screen of FIG. 1 with the “Cost Assumptions” subscreen expanded.

FIG. 7 depicts a seventh screenshot of the present embodiment, showing the data input screen of FIG. 1 with the “Financing Assumptions” subscreen expanded.

FIG. 8 depicts a eighth screenshot of the present embodiment, showing the data input screen of FIG. 1 with the “Project Metrics” subscreen expanded.

FIG. 9 depicts a ninth screenshot of the present embodiment, showing the “Plant Specifications” screen.

FIG. 10 depicts a tenth screenshot of the present embodiment, showing a first segment of the “Utilization Profile” screen.

FIG. 11 depicts an eleventh screenshot of the present embodiment, showing partial utilization data for a first well, in a first segment of the “Utilization Profile” screen.

FIG. 12 depicts an twelfth screenshot of the present embodiment, showing a second segment of the “Utilization Profile” screen, and in particular a utilization/treatment graph generated by the present embodiment.

FIG. 13 depicts the “Change-Out Schedules” screen, in accordance with the present embodiment.

FIG. 14 depicts a fourteenth screenshot of the present embodiment, showing a first segment of the “Change-Out Schedules” screen.

FIG. 15 depicts a fifteenth screenshot of the present embodiment, showing a second segment of the “Change-Out Schedules” screen, and in particular a graph depicting the months during which well change-out is required, as generated by the present embodiment.

FIG. 16 depicts a sixteenth screenshot of the present embodiment, showing the “Start-Up Costs” Screen.

FIG. 17 depicts a seventeenth screenshot of the present embodiment, showing the “Financial Schedules” screen.

FIG. 18 depicts a eighteenth screenshot of the present embodiment, showing the “Debt Amortization” subscreen of the “Financial Schedules” screen of FIG. 15.

FIG. 19 depicts a nineteenth screenshot of the present embodiment, showing the “Revenue” subscreen of the “Financial Schedules” screen of FIG. 15.

FIG. 20 depicts an twentieth screenshot of the present embodiment, showing the “Operating Expenses” subscreen of the “Financial Schedules” screen of FIG. 15.

FIG. 21 depicts a twenty-first screenshot of the present embodiment, showing the “Change-Out Expenses” subscreen of the “Financial Schedules” screen of FIG. 15.

FIG. 22 depicts a twenty-second screenshot of the present embodiment, showing the “Capital Asset Acquisitions” subscreen of the “Financial Schedules” screen of FIG. 15.

FIG. 23 depicts a twenty-third screenshot of the present embodiment, showing the “Capital Asset Amortizations” subscreen of the “Financial Schedules” screen of FIG. 15.

FIG. 24 depicts a twenty-fourth screenshot of the present embodiment, showing the “Equity Cash Flows” subscreen of the “Financial Schedules” screen of FIG. 15.

FIG. 25 depicts a twenty-fifth screenshot of the present embodiment, showing the “Monthly Financials” screen.

FIG. 26 depicts a twenty-sixth screenshot of the present embodiment, showing the “Income Statement” subscreen of the “Monthly Financials” screen of FIG. 23.

FIG. 27 depicts a twenty-seventh screenshot of the present embodiment, showing the “Balance Sheet” subscreen of the “Monthly Financials” screen of FIG. 23.

FIG. 28 depicts a twenty-eighth screenshot of the present embodiment, showing the “Cash Flow Statement” subscreen of the “Monthly Financials” screen of FIG. 23.

FIG. 29 depicts a twenty-ninth screenshot of the present embodiment, showing the “IRR & NPV Calculations,” “Payback Period,” and “Debt Service Coverage Ratios” subscreens of the “Monthly Financials” screen of FIG. 23.

FIG. 30 depicts a thirtieth screenshot of the present embodiment, showing the “Annual Financials” screen.

FIG. 31 depicts a thirty-first screenshot of the present embodiment, showing the “Income Statement” subscreen of the “Annual Financials” screen of FIG. 30.

FIG. 32 depicts a thirty-second screenshot of the present embodiment, showing the “Balance Sheet” subscreen of the “Annual Financials” screen of FIG. 30.

FIG. 33 depicts a thirty-third screenshot of the present embodiment, showing the “Cash Flow Statement” subscreen of the “Annual Financials” screen of FIG. 30.

FIG. 34 depicts a thirty-fourth screenshot of the present embodiment, showing the “IRR & NPV Calculations” subscreen of the “Annual Financials” screen of FIG. 30.

FIG. 35 depicts a thirty-fifth screenshot of the present embodiment, showing the “Payback Period” subscreen of the “Annual Financials” screen of FIG. 30.

FIG. 36 depicts a thirty-sixth screenshot of the present embodiment, showing the “Debt Service Coverage Ratios” subscreen of the “Annual Financials” screen of FIG. 30.

### DETAILED DESCRIPTION OF THE INVENTION

Generally, one embodiment of the present invention takes the form of a computer program for calculating expenses and profits associated with disposal of treatment media. A user of the present invention may specify certain parameters, such as the location of the media to be disposed, the site of disposal, timing data, well characteristics, properties of the disposal media, assumptions relating to revenue, cost, and financing, and project metrics. The embodiment employs this data to generate plant specifications (i.e., the characteristics of the plant used to recover contaminants from liquids), a utilization profile (i.e., an overview of the number of gallons per months of contaminated liquid treated at various utilization levels), change-out schedules (i.e., the dates at which wells should be changed out due to reaching treatment capacity), start-up costs for the treatment plant, and financial schedules on monthly and annual bases. Generally speaking, one embodiment of the present invention is configured to calculate profits and expenses associated with using zeolite as a filtering agent, typically to filter radium from groundwater. Alternate embodiments may be configured to calculate profits and expenses associated with filtering uranium, cesium, strontium, and so forth from a liquid, along with disposal of the associated filtering agent.

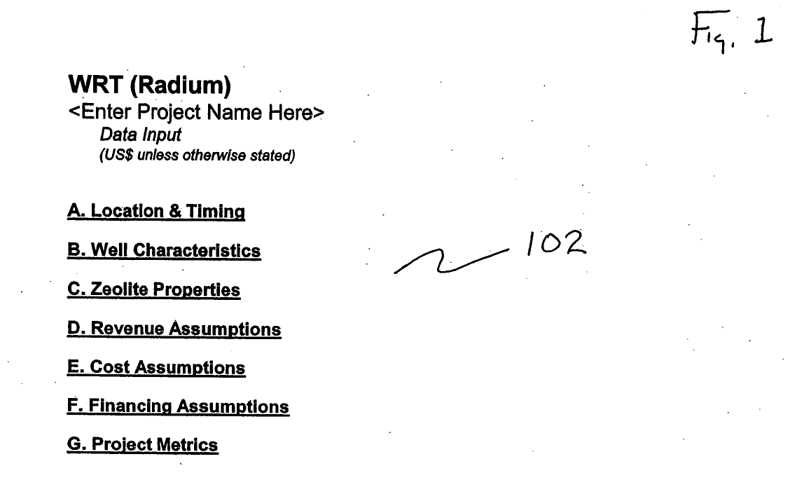

FIG. 1 generally depicts a data entry screen of a first embodiment of the present invention. The data entry screen 102 is divided into seven categories, namely “Location and Timing,” “Well Characteristics,” “Zeolite Properties,” “Revenue Assumptions,” “Cost Assumptions,” “Financing Assumptions,” and “Project Metrics.” Each category is expandable, and permits a user to input data relating to that category. Each set of data inputs is used to generate pricing and operational data, as explained in greater detail below. Initially, each category will be discussed in detail.

Although the present embodiment lists seven categories, alternative embodiments may employ additional categories, may divide data entry between categories differently, or may omit categories. Similarly, the present embodiment may be configured to provide pricing and operational data for chemicals, compounds, contaminants, and/or elements other than radium, as discussed in more detail below. For example, an alternative embodiment of the present invention may account for pricing and operation of uranium or cesium disposal. Yet other embodiments may be configured to provide such information for multiple contaminants, compounds, chemicals, elements, and so forth. Accordingly, the present set of categories and the inclusion of zeolite as a filtering agent therein should be taken as exemplary, rather than limiting.

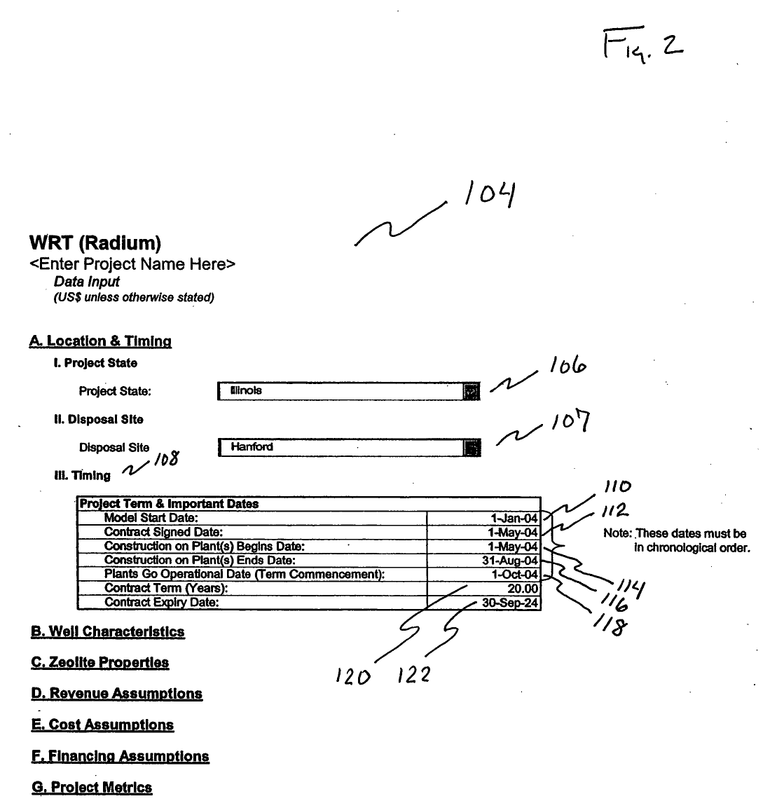

FIG. 2 depicts the “Location and Timing” category in an expanded state. Generally, this category contains and/or accepts data inputs associated with the location of the contaminated material to be shipped, the shipping destination, and the timing of the cleanup operation. For example, the “project state” field 106 takes the form of a drop-down box listing all states in the United States. A user may select the state in which the contaminated material is located from the list in the project state field (i.e., the state in which the cleanup project is to take place). It should be noted alternative embodiments may be designed to list countries outside the Untied States, as well as states, provinces, or other geographic or political regions in such countries. In like vein, the project state field may list different regions within the United States. For example, an alternative embodiment may divide the United States into northern, southern, eastern, and western regions, instead of by state.

Similarly, the “disposal site” field 107 includes a drop-down box listing the various waste disposal sites. In the present embodiment, three possible disposal sites are listed: Grandview, Hanford, and Newpark. Alternative embodiments may include more or fewer disposal sites, and may omit one or more of those listed by the present embodiment. For example, alternative embodiments may include Yucca Mountain, the Savannah River Site, and so forth as disposal sites. It should be noted to disposal sites listed may vary depending on what contaminant and/or material is chosen for cleaning and/or disposal. For example, in an embodiment permitting a user to choose a given contaminant and/or material, the disposal sites display may be tied to the choice of contaminant. Thus, if the user chooses zeolite as the material of choice, one set of disposal sites may be listed. If, however, the user chooses uranium or strontium as the material, a different set of disposal sites may be available from which to choose.

Timing data is also displayed in, and may be entered from, FIG. 2. For example, the timing data section 108 of the “Location & Timing” subscreen 104 permits entry of a variety of timing data. A user may enter the start date for the model generated by the present embodiment 100 in the “start date” field 110, the date any contract to remove contaminants is signed in the “contract signed” field 112, the date construction of a remediation plant begins in the “construction begins” field 114, the date construction of the remediation plant ends in the “construction end” field 116, the date the plant becomes operational in the “plant operational” field 118, the duration of the remediation contract in the “contract term” field 120, and the date the contract expires in the “contract expiry” field 122. This data may be used to calculate certain outputs, such as change-out schedules, financial schedules, well utilization profiles, and so forth, as described below. It should be noted that certain embodiments of the present invention may require the timing fields 110, 112, 114, 116, 118, 120, 122 to be populated with dates in a particular chronological order, while others may not. For example, some embodiments may require the “contract signed” field to have a date occurring prior to the “contract begins” date.

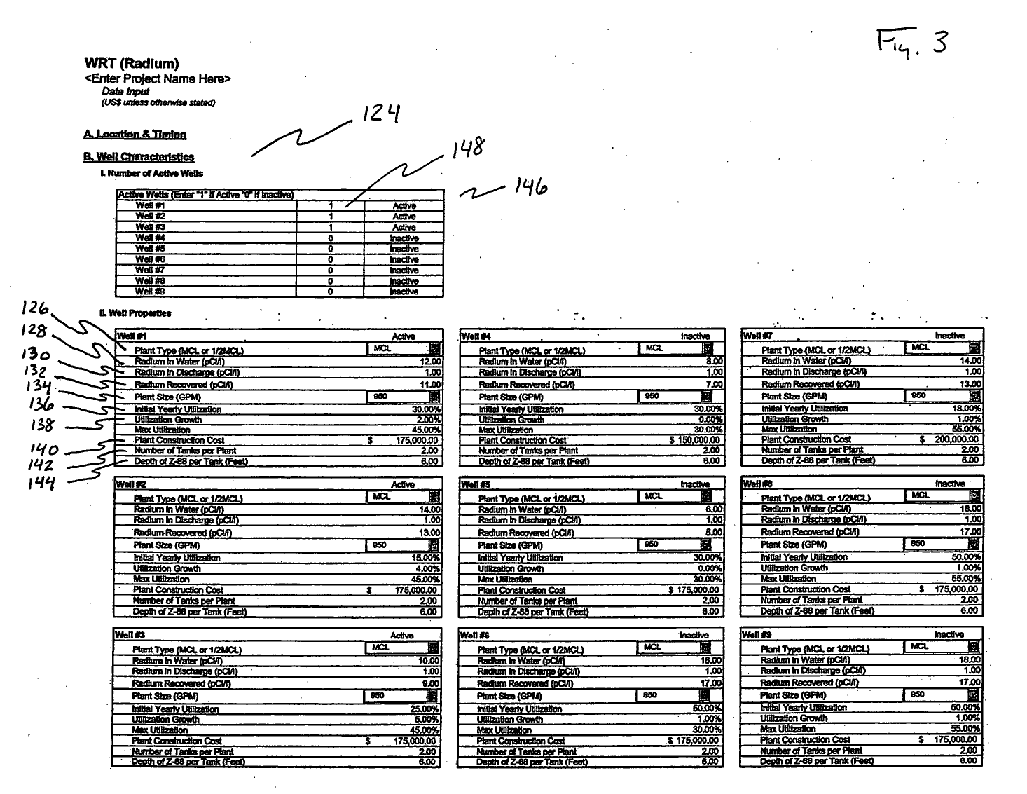

The Data Input screen 102 also includes the well characteristics subscreen 124, shown in FIG. 3. This subscreen permits a user to identify active and inactive (or nonexistent) wells, in addition to specifying certain operational parameters for each operational well. In certain embodiments, a user may specify operational parameters for an inactive well. This may permit the embodiment and user to plan for the eventual activation of such wells, and/or evaluate the profitability of various scenarios employing different numbers of active wells.

The well characteristics subscreen 124 includes a variety of data input fields. For example, the plant type field 126 permits a user to specify from a dropdown box whether the plant will be a MCL or ½ MCL plant. “MCL” stands for “maximum contamination level,” and is a measurement of the maximum level of contaminants that may be present after the liquid is cleaned. Groundwater, for example, generally has a MCL set by either the federal or state governments. It should be noted, further, that the present embodiment is particularly suitable for calculating costs and profits associated with the cleaning of groundwater, construction of plants to perform such cleaning, and disposal of filtering agents used to clean groundwater.

A user may specify in the “radium in water” field 128 the amount of radioactive material in the liquid being cleaned, in terms of picocuries per liter. It should be noted that the liquid being cleaned is typically water, but may be any type of liquid.

Just as the user may specify the radioactivity of the water to be cleaned, he may specify the radioactivity of the cleaned discharge in the “radium in discharge” field 130. The embodiment 100 employs the radium in water field 128 and radium in discharge field 130 to calculate the radium recovered, which is displayed in the “radium recovered” field 132. The radium recovered value is calculated by subtracting the entered radium in discharge value from the entered radium in water value.

It should be noted that, while the present embodiment 100 permits a user to specify radium levels in input and output liquids, alternate embodiments may permit a user to specify levels of other contaminants such as uranium, cesium, and so forth.

The embodiment 100 accepts data indicating a plant size, for each well, in gallons per minute. This measures the flow of contaminated liquid out of each well, into the plant, and through the plant tanks. The data may be inputted into the “plant size” field 134, or selected from a dropdown box. Similarly, the initial yearly utilization of the well's capacity may be inputted into the “initial utilization” field 136 as a percentage. The annual increase in well utilization is specified in the “utilization growth” field 138, again as a percentage. In some embodiments, the utilization growth is a percentage of the well's absolute capacity, while in others it is a percentage of the initial utilization of the well.

A user may also input a cost, in U.S. dollars, for constructing the plant/well into the “plant construction cost” field 140, and the number of tanks per plant in the “tanks per plant” field 142. Generally speaking, each plant typically corresponds to a single well, but may have one or more tanks. By way of definition, the “plant” encompasses the entire processing setup of contaminated liquid, the “well” is the reservoir from which contaminated liquid is drawn, and a “tank” is a storage unit for filtering the contaminated and/or cleaned liquid.

Finally, a user may also specify the depth of zeolite (or other filtering material) per tank, in feet, in the “Z-88 per tank” field 144. It should be noted that alternate embodiments may employ different filtering materials, which may be inputted into a similar field. The filtering material used may depend on the costs of filtering material, contaminant being filtered/cleaned, and so forth.

Before leaving the well characteristics subscreen 124, the “active wells” area 146 should be discussed. The active wells area 146 lists a series of wells (in the present embodiment 100, nine) and the status of each well (i.e., active or inactive). The status of a well may be changed by changing the active tag 148 from a zero, indicating inactive, to a one, indicating active. Alternate embodiments may employ more or fewer wells in the active wells area 146. Whether a well is active or inactive is displayed in the well characteristics subscreen for each well. Further, if a well is inactive, the entries in the various fields corresponding to that well are ignored by the embodiment 100 when calculating and displaying the various data discussed below. Only if a well is active are the data inputs processed in accordance with the present embodiment.

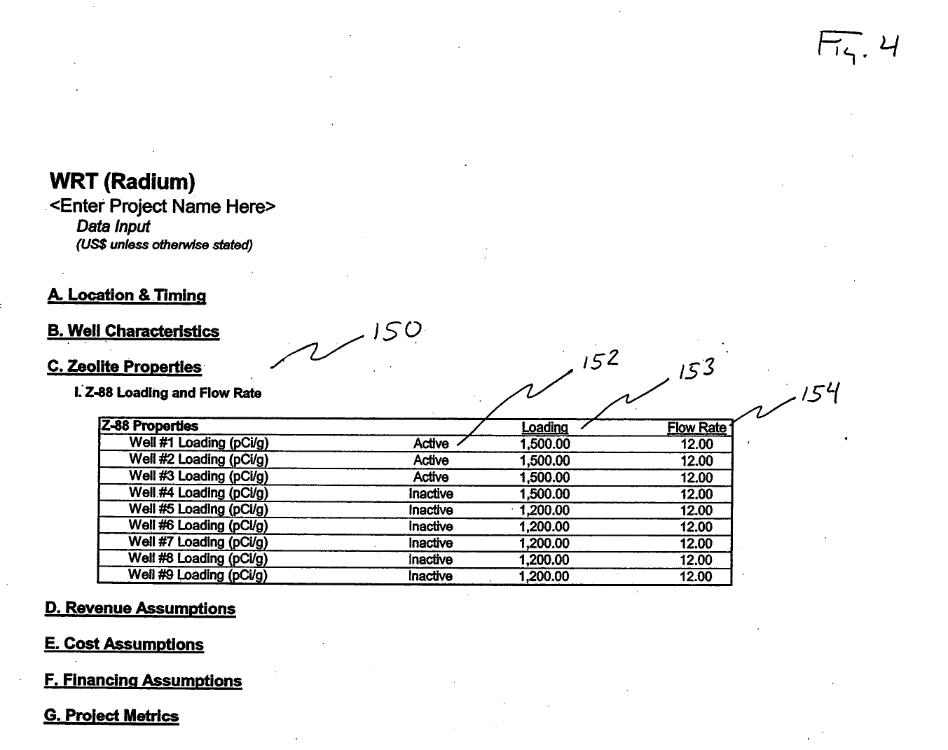

The data input screen 102 further contains a “zeolite properties” subscreen 150, depicted in FIG. 4. The zeolite properties subscreen displays each well's activity status (active or inactive) in the “well active” display 152. A user may enter the loading of the well in the “loading” field 153. The well loading measures the maximum radioactive absorption of the zeolite in terms of picocuries per gram, rather than picocuries per liter. That is, each gram of zeolite (or other absorptive/filtering material, in alternate embodiments) may absorb a certain measure of radioactivity, expressed as picocuries. That maximum absorption is entered in this field by the user.

In addition to the well loading, the flow rate of contaminated liquid through the zeolite or other absorptive material may be inputted by the user into the “flow rate” field 154. The flow rate is measured in gallons per square foot (of filtering material) per minute, and indicates the amount of contaminated liquid flowing through a square foot the filtering agent every minute. As a general rule, the flow rate of contaminated liquid through the zeolite bed in each tank is controlled by the plant operator. Higher flow rate typically produce faster outflow, and thus quicker exhaustion of the well. However, high flow rates may also move the contaminated liquid through the filtering agent too quickly for the agent to absorb a sufficient amount of radioactivity or contamination, resulting in insufficiently cleaned discharge. Thus, a balance must be struck between speed of discharge and absorption by the filtering agent.

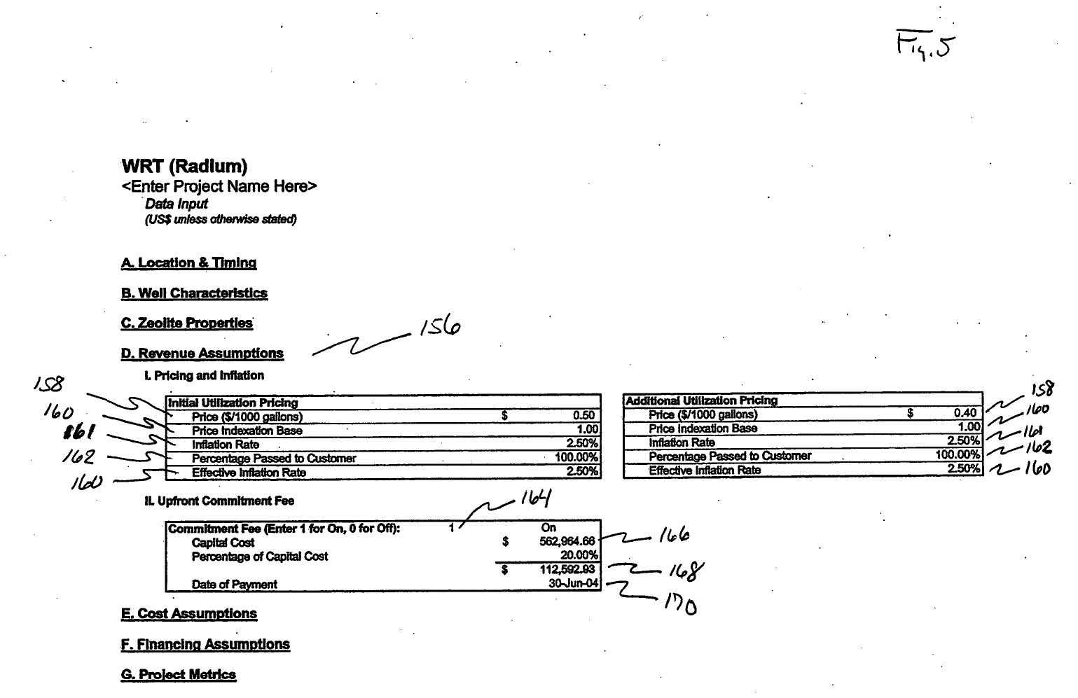

The “Revenue Assumptions” subscreen 156, shown in FIG. 5, is another subscreen of the Data Input screen 102. A user may input certain estimates and details regarding pricing and cost commitments in this field for use in forecasting expenses and revenue. For example, the revenue assumptions subscreen includes a section for determining pricing and utilization fees, as well as commitment fees.

A user may input the price per thousand gallons to operate the plant, at least initially, in the “utilization price” field 158. The utilization price generally corresponds to the price the plant operator charges to filter or otherwise clean 1,000 gallons of contaminated liquid. This value may take into account, for example, the estimated cost of the zeolite or filtering agent, the tank, pumping of the contaminated liquid, and so forth. By contrast, the value in the “price indexation base” field 160 represents a base value by which all prices are indexed. A value of “1” indicates standard indexation; values greater than 1 increase pricing accordingly, while values below 1 reduce pricing. For example, a value of “2” indicates double the standard price indexation value.

An estimated annual inflation rate may be entered by a user in the “inflation rate” field 161. The embodiment 100 may employ this information in its forecasting to adjust pricing, costs, and profits by estimated inflation values.

The user may specify what portion of the projected inflated costs is passed to the customer in the “percentage passed to customer” field 162. The embodiment 100 may employ this data, along with the value entered in the inflation rate field 160, to calculate the effective inflation rate seen by the customer. The effective inflation rate equals the estimated inflation rate of field 160, multiplied by percentage of inflation passed to the customer.

In addition to entering the above-referenced data for the initial utilization of the plant, similar data may be entered to correspond to further plant usage. This may, for example, permit a user to give a customer a price discount on filtering or cleaning of contaminated liquids after a certain point is reached. The data fields are the same as those already discussed.

The revenue assumptions subscreen 156 may also accept data relating to upfront commitment costs to open, construct, and/or operate a filtration plant. For example, the commitment fee field 164 determines whether any upfront commitment at all is required. If so, a value of “1” is entered in the field. Otherwise, a value of “0” is entered.

If a commitment fee is required, the capital cost of the plant is entered, in U.S. dollars, in the “capital cost” field 166. As with other fields accepting monetary inputs, alternate embodiments may be configured to accept inputs in other currencies. The embodiment multiplies the capital cost by the percentage to determine the upfront commitment. The upfront commitment is displayed in the upfront commitment field 168.

Finally, the date the upfront commitment must be paid is entered in the “date of payment” field 170.

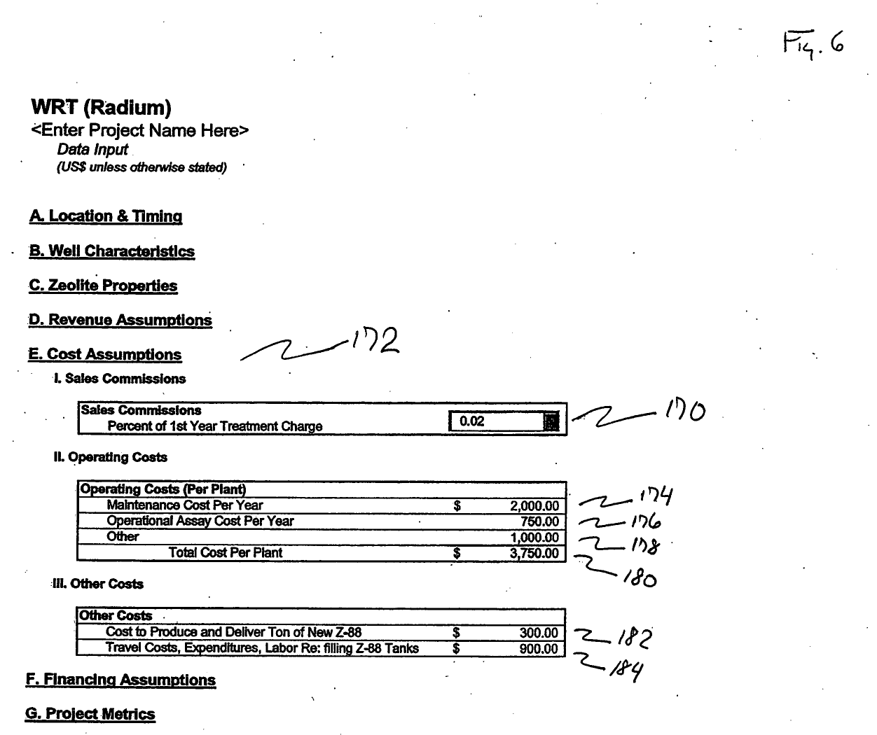

Turning now to the “Cost Assumptions” subscreen 172 (shown in FIG. 6), a user may enter data related to the broad categories of sales commissions, operating costs, and other costs. The sales commission given to the person or entity landing the remediation contract is entered in the “sales commissions” field 170 as a percentage. This equates to a percentage of the charge levied by the plant operator for the first year of plant operation and liquid treatment. Most times, this value will be a fraction of a percent.

A user may enter the yearly maintenance cost of the plant, in U.S. dollars, in the “maintenance cost” field 174. The yearly operational costs are entered in the “operational assay cost” field 176, and miscellaneous operational costs in the “other” field 178. These costs are summed to yield the total yearly operating cost per plant, which is displayed in the “total cost per plant” field 180.

The user may specify the cost to produce and deliver a ton of filtering agent (such as zeolite) in the “cost to produce” field 182. The user may also input costs associated with filling a plant tank with filtering agent, such as transportation costs, expenditures, and labor, in the “travel costs” field 184.

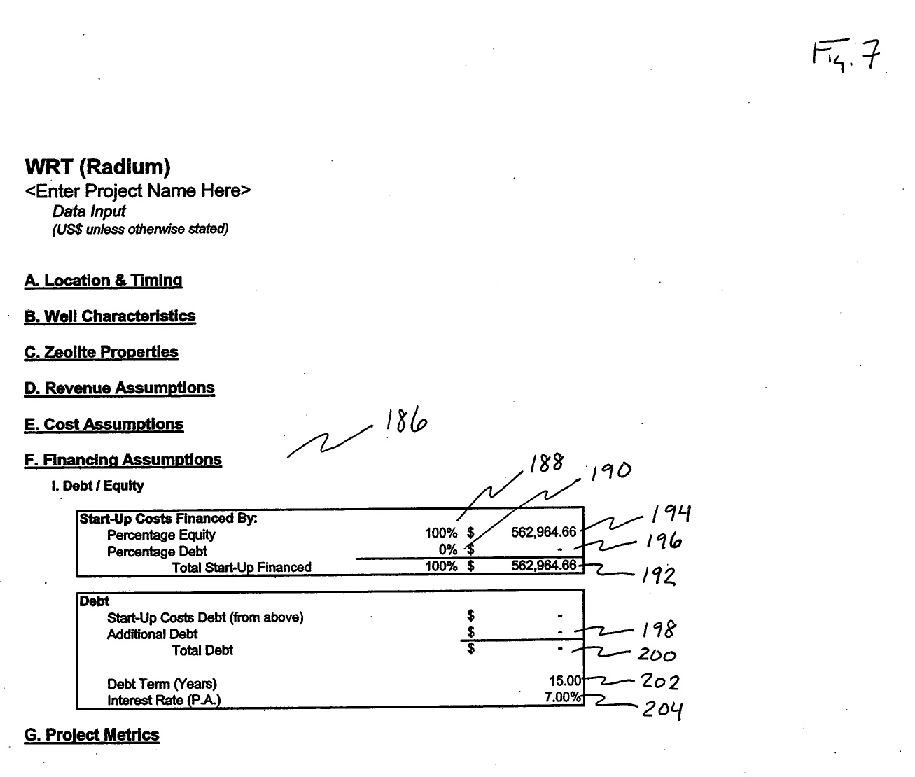

Depicted in FIG. 7, the “Financing Assumptions” subscreen 186 permits a user to enter the percentage of start-up costs financed by both equity and debt in the “percentage equity” and “percentage debt” fields 188, 190, respectively. The total start-up costs are calculated by adding the plant construction cost for each active well (specified in the plant construction cost field 140), plus a materials cost for each active well, plus the cost of the initial zeolite charge for the plant.

In the present embodiment 100, the materials cost per well is $103.00, although this cost is an estimate and may vary with the plant size, plant type, filtering agent employed, and so forth. Generally speaking, the materials cost increases with flow rate. Thus, if the value in the plant size field is 500 or less, the materials cost per well is estimated to be $75.00. If the value in the plant size field ranges from 501 to 1000, the materials cost per well is estimated by the present embodiment 100 to be $103.00. If the value in the plant size field 134 is more than 1000 but equal to or less than 1500, the materials cost per well is estimated by the present embodiment to be $155.00. If the value in the plant size field 134 exceeds 1500, the present embodiment estimates the materials cost per well to be $206.00.

Further, the initial zeolite charge cost is estimated by the present embodiment 100 based on a number of factors. The embodiment takes the number of tons of zeolite required per plant, multiplies it by the cost per ton of zeolite (inputted in the cost to produce field 182, which may include a delivery charge, adds a shipping/transport cost for a tank of zeolite (equal to an estimated mileage multiplied by an estimated transport), adds the cost to set up each tank of zeolite (inputted in the travel cost field 184), and multiplies the sum by the number of tanks in the plant (inputted in field 142). The embodiment 100 determines the estimated mileage by calculating the distance from a place at which the filtering agent is procured to a fixed point in the state of operation (inputted in the project state field 106). In alternate embodiments, a mapping program or mapping website may be automatically accessed by the present embodiment 100 to calculate an actual mileage from the loading point to the project site, instead of using an estimate. It should also be noted that the cost to transport may vary with the number of tons of zeolite used to line each operational tank. Generally speaking, the cost to transport increases with the number of tons of zeolite per tank.

An example may assist in understanding this calculation. As shown in FIGS. 2-7, the present example presumes three active wells. The plant for each well costs $175,000 to build, and has a flow rate of 950 gallons per minute. Further, the project site is in Illinois, and the filtering material is to be disposed in Hanford, Wash. The user has further specified that each tank requires a $900.00 surcharge in materials and labor and initial loading of the filtering agent into the plant.

Further presume 13.09 tons of zeolite are required per tank at a cost of $300.00 per ton, and that the well requires the two specified tanks (specified in the tanks per plant field 142). Given the number of tons of zeolite required per tank, the embodiment 100 may estimate a transport cost of $1.50 per mile when the zeolite is shipped to the plant. The embodiment also estimates the mileage between the plant location and the point at which the filtering agent is obtained. In this case, the embodiment 100 estimates the mileage to be 966 miles. This estimate is used regardless of the location of the plant within the state of operation. Accordingly, shipping of fresh zeolite would cost ($1.50)×(966)=$1,449.00.

The embodiment 100 further may estimate the materials cost per well to be $103.00, based on the flow rate of 950 gallons per minute Thus, the initial cost of the plant (exclusive of the actual well cost) is ((13.09)×(300)+(966×1.5)+900)×2=$12,552.00. This initial cost equals the initial zeolite cost, plus transportation fees for fresh zeolite, plus the materials and labor surcharge, times two because two tanks are constructed for the well.

To the initial cost is added the $103.00 per well materials charge, for a total of $12,655.00. Finally, the well/plant construction cost of $175,000.00 is added to this total, for a plant total of $187,655.00. Since three identical wells are active in the example, this total may be multiplied by three for a final commitment cost of $562,965.00. This value is depicted in the “start-up financing total” field 192. The embodiment multiplies the value of the percentage equity field 188 times the start-up equity total field to yield a start-up equity total, displayed by the embodiment 100 in the “start-up equity” field 194. A similar calculation is employed to calculate the start-up debt total, which is displayed by the embodiment in the “start-up debt field” 196. The sum of the start-up equity and start-up debt field 194, 196 equals the value of start-up financing total field 192.

A user may also enter additional debt data into the embodiment 100. For example, a user may specify in the “additional debt” field 198 any additional debt beyond the portion of the start-up costs financed by debt. The value of the start-up debt field 196 and additional debt field 198 are summed to produce a total debt, displayed in the “total debt” field 200. A user may also enter a term in which the debt will be paid off, measured in years, in the “debt term” field 202, as well as an annual interest rate to which the debt is subjected in the “interest rate” field 204.

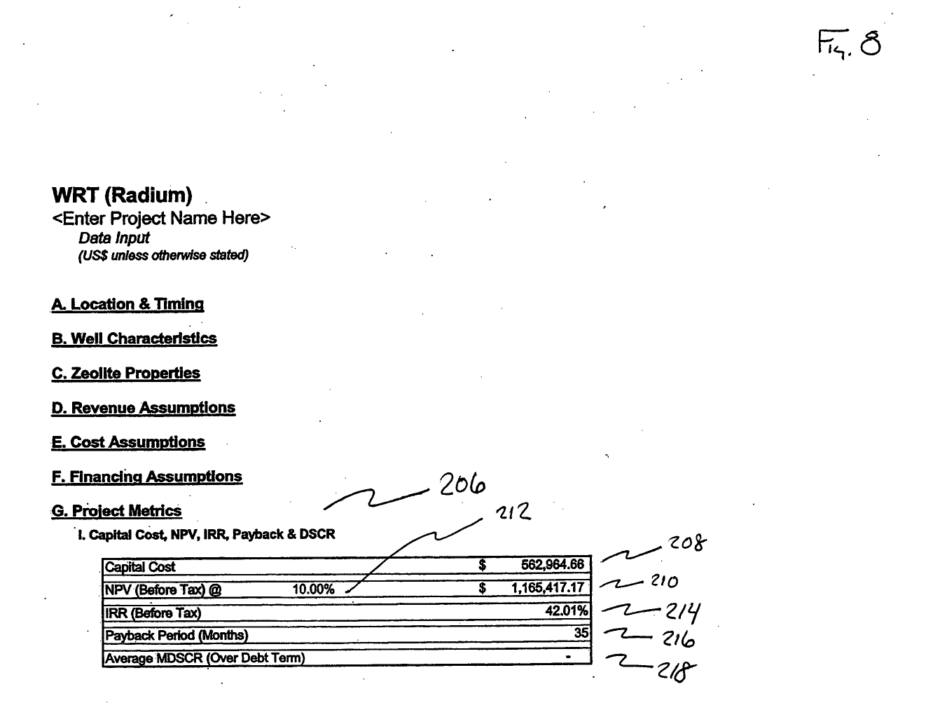

The final subscreen of the data input screen 102 is the “Project Metrics” screen 206, and is shown in FIG. 8. The project metrics screen 206 includes fields for displaying various high-level project measurements. For example, the “capital cost” field 208 displays the total capital cost required for the project, and is generally equal to the value of the start-up total financing field 192.

Also displayed is the pre-tax net present value of the start-up equity in the NPV field 210. In order to calculate the net present value of a project, a user must provide the present embodiment 100 with an interest rate used to discount the annual value of the project. This interest rate is inputted in the “NPV rate” field 212.

The embodiment 100 may also calculate the pre-tax internal rate of return (IRR) on the start-up equity invested in the plant. The pre-tax IRR is calculated from the monthly equity cash flows in a manner known to those skilled in the art, and displayed in the IRR field 214. Given the financial data inputted by the user, the embodiment may also calculate the number of months required to pay back the start-up equity cost. This number is displayed in the “payback period” field 216. It should be noted that the number of months required to pay back the start-up equity (i.e., the number of months before a positive cash flow is generated by the remediation plant) is measured in the present embodiment 100 from the date the plant becomes operational, rather than the date a contract is signed or money is invested.

Finally, the embodiment may calculate the average monthly debt service coverage ratio (MDSCR), which is displayed in the “average MDSCR” field 218. Calculation of the monthly debt service coverage ratios is discussed in more detail below.

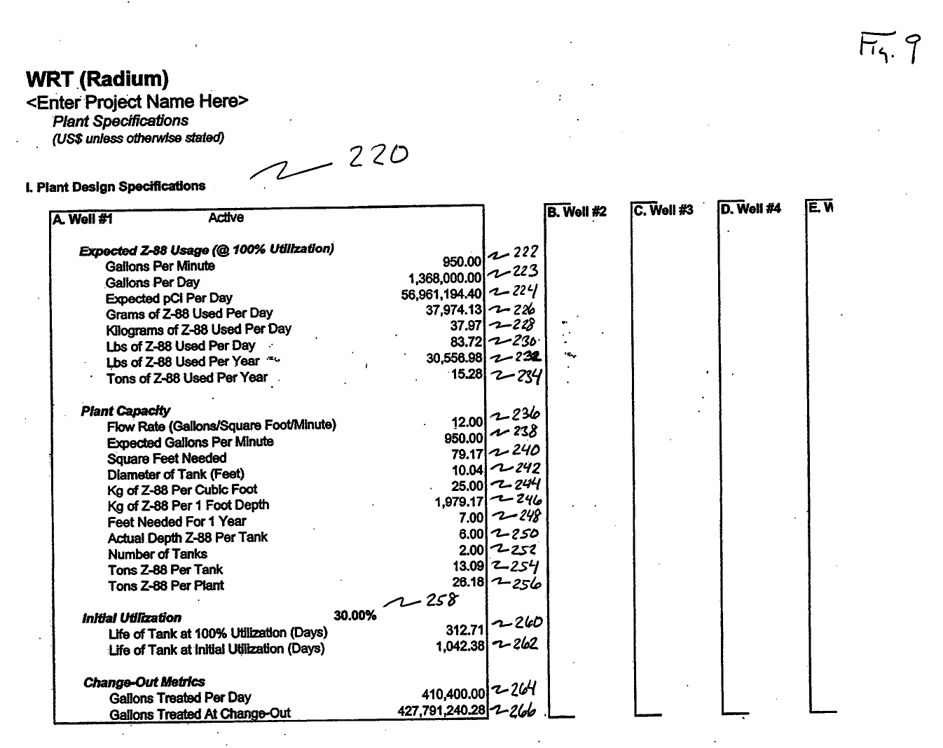

FIG. 9 depicts the plant design specifications screen 220. The plant design specifications screen displays certain operational parameters for each well of the plant. FIG. 9 depicts the various data fields for a single well, namely well #1. Generally speaking, the data fields (although not necessarily the values therein) are identical for each well. The data fields may be broken down into four major categories: expected zeolite usage, plant capacity, initial utilization data, and change-out metrics. Each category discloses a different metering of plant operation and design.

For example, multiple data field appear in the expected zeolite (or Z-88) usage category. Each of these data fields is populated by the embodiment 100, based on the data inputs provided by the user at the data input screen 102. The “gallons per minute” field 222 indicates the flow rate from the well into the plant, as specified in the plant size field 134 of the well characteristics subscreen 124. Another useful metric is the number of gallons flowing from the well into the plant in a given day, which can be calculated from the gallons per minute value 222 and displayed in the “gallons per day” field 223.

Since the user has already specified the radium recovered from the well in terms of picocuries per liter (in the radium recovered field 132), the embodiment 100 may employ this data, along with the gallons of flow per day, to calculate the expected picocuries of radioactive material to be absorbed by the zeolite or other filtering agent. The value of the radium recovered field 132 is multiplied by a liter-to-gallon conversion factor to yield the amount of radium recovered in picocucries per gallon; this number is then multiplied by the value of the gallons per day field 222 to yield an measurement of the radioactive material filtered by the zeolite in a given day, expressed in picocuries per day. The resulting value is displayed in the “expected picocuries per day” field 224.

Recall that the user has also specified the loading of the zeolite in the loading field 153 of the zeolite properties subscreen 150. The embodiment 100 may determine the number of grams of zeolite used to filter the contaminated water, per day, by dividing the value of the expected picocuries per day field 224 by the value of the loading field 153. This yields a number of grams of zeolite necessary each day to absorb and/or filter the radioactive waste present in the contaminated liquid. This value is displayed in the “grams per day” field 226. It should be noted this calculation yields the grams of zeolite used per day per well, rather than the zeolite necessary per tank.

Once the number of grams of zeolite used per day is known, the embodiment 100 may calculate the kilograms of zeolite used per day, pound of zeolite used per day, pounds of zeolite used per year, and tons of zeolite used per year by applying the appropriate conversion factors. These data are displayed in the “kilograms per day” field 228, “pounds per day” field 230, “pounds per year” field 232, and “tons per year” field 234, respectively.

Several factors and calculated data determine the plant capacity. The first such factor is the flow rate of liquid from the well through the plant, and accordingly through the zeolite bed(s) of the tank(s). This value is specified by the user in the flow rate field 154 of the zeolite properties subscreen 150, and is depicted on the plant specifications screen 220 in the “flow rate” field 236. The expected gallons per minute of flow through the plant is displayed in the “gallons per minute” field 238, and is taken from the plant size field 134 on the well characteristics subscreen 124. With these two values, the embodiment 100 may calculate the square footage of zeolite required for operation, by dividing the flow rate by the expected gallons per minute. The result is displayed in the “square feet needed” field 240. From the square feet needed, the diameter of the tank, in feet, may be calculated. The embodiment divides the square feet needed by pi, takes the square root of the value, and multiplies it by two. The result is displayed in the “diameter of tank” field 242.

Generally, the number of kilograms of zeolite per cubic foot is a constant, presuming level surfaces and settling of the zeolite to an average density. Typically, there are approximately 25 kilograms of zeolite per cubic foot; this value is displayed in the “kilograms per cubic foot” field 244. Given this constant and the number of square feet of zeolite required (displayed in field 240), the number of kilograms of zeolite per foot of tank depth may be calculated. The result is shown in the “kilograms per one foot depth” field 246.

The feet of zeolite or other absorptive agent needed to operate the plant for one year is displayed in the “feet per year” field 248. This value may be calculated by dividing the pounds of zeolite used per year (shown in field 232) by the number of kilograms of zeolite per foot of depth (shown in field 246), and further dividing the pounds of zeolite used per year by a factor converting pounds to kilograms.

The “actual depth per tank” field 250 displays the depth of zeolite in each tank, measured in feet. This value is taken from the “Z-88 per tank” field 144 of the well characteristics subscreen 124. Similarly, the value shown in the “number of tanks” field 252 is taken from the tanks per plant field 142 of the well characteristics subscreen 124. The tons of zeolite per tank is displayed in the “tons per tank” field 254, and is determined by multiplying the value in the kilograms per one foot depth field 246 by the value of the actual depth per tank field 250, and dividing by a constant converting kilograms to pounds. The tons of zeolite per plant is displayed in the “tons per plant” field 256, and is calculated by multiplying the value of the tons per tank field 254 by the value of the number of tanks field 252.

The value from the initial utilization field 136 of the well characteristics subscreen 124 is also displayed in the “plant initial utilization” field 258. The embodiment 100 may calculate the number of days a tank of zeolite will last at both 100% utilization and the initial utilization, and display the results. For the duration of the tank life at 100% utilization, the embodiment divides the number of tons of zeolite in the tank (displayed in the tons per tank field 254) by the number of tons of zeolite used per year (displayed in the tons per year field 234), and multiplies the result by 365 (the number of days in one year). The resulting number is the number of days the zeolite in the tank will perform its filtering/absorbing function, and is displayed in the “life of tank at 100% utilization” field 260.

A similar calculation may be employed by the embodiment 100 to determine the tank life, in days, at the initial utilization rate. The number of tons of zeolite used per year is divided by the product of the tons of zeolite used per year and the initial utilization rate. This number is then multiplied by 365 to convert from years to days, and the end result is displayed in the “life of tank at initial utilization” field 262.

Finally, the embodiment 100 may calculate and display certain change-out metrics for the zeolite lining the tanks. For example, the embodiment may calculate the number of gallons of contaminated liquid treated per day, and display the number in the “gallons treated per day” field 264. This is determined by multiplying the value of the gallons per day field 223 by the initial utilization rate 136, 258. Similarly, the number of gallons treated by the time the zeolite in each tank is changed out may be computed and displayed in the “gallons treated at change-out” field 266. The number of gallons treated by the time the zeolite is replaced is computed multiplying the value of the life of tank at initial utilization field 262 by the value of the gallons treated per day field 264.

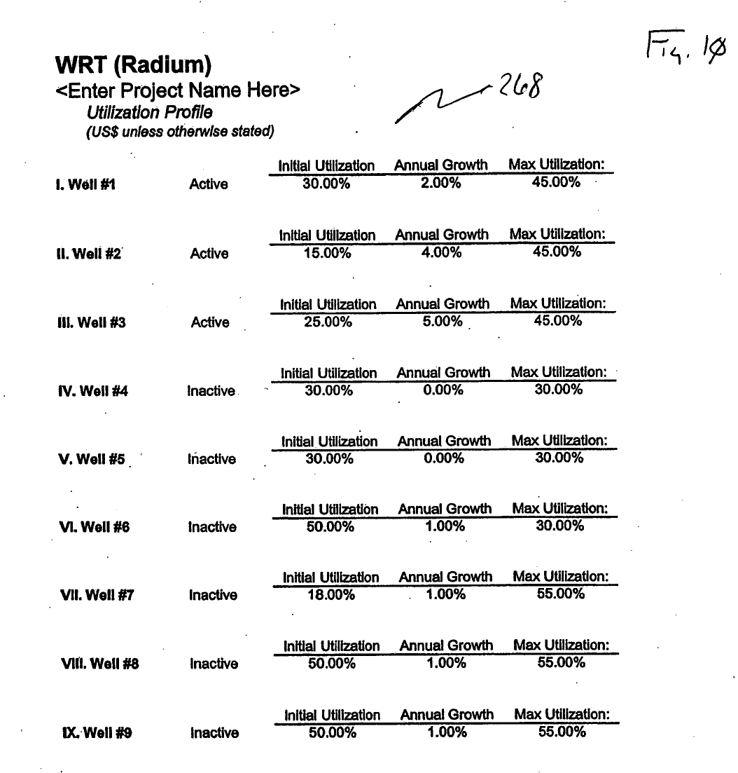

In addition to calculating certain plant specifications from the data inputs, the present embodiment may prepare a utilization profile for the plant. Generally speaking, the utilization profile (depicted broadly in the utilization profile screen 268 of FIG. 10) displays the annual (and optionally weekly, monthly or another time period) growth and utilization rate for each active well. The utilization rate may increase on a monthly and/or annual basis; this increase is also reflected in the utilization profile.

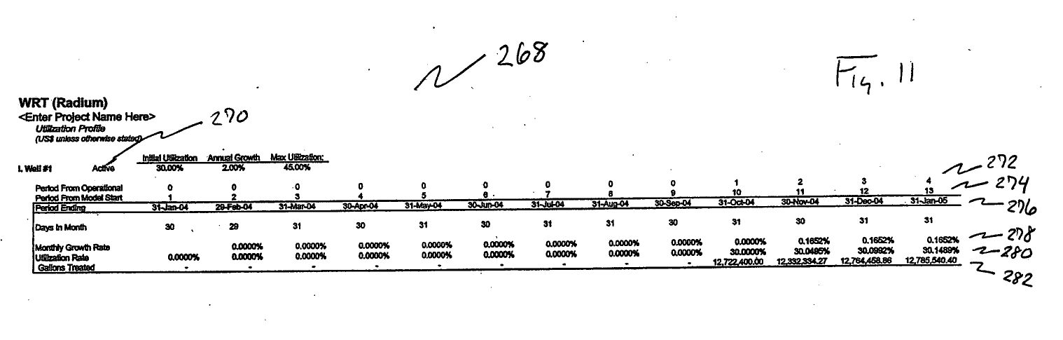

A utilization profile is displayed for each well, along with whether the well is active or inactive. A sample well profile is shown in FIG. 11. Each well's activity status is shown in the well activity window 270; this information is taken from the active tag 148 for each well. In some embodiments, utilization profiles may be created only for those wells flagged as “active” by the active tag 148. This, in turn, may minimize processing requirements.

The utilization profile for each well also displays the well's specified initial utilization, annual utilization growth, and maximum utilization. Each of these values is taken from the appropriate data fields of the data input screen 102.

Generally, the utilization profile begins with the month inputted in the start date field 110, and runs through the duration of the contract specified in the contract term field 120. The embodiment 100 may indicate the number of months since the plant became operational in the “period from operational” field 272, and the number of months from the model start date in the “period from model start” field 274. The month in which the plant becomes operational is specified by the user in the plant operational field 118. Months prior to the beginning of operations have a zero value for the period from operational field. The end date of each period is also specified in the “period ending” field 276.

Although the present embodiment 100 is set up to employ monthly periods, alternate embodiments may employ periods having different durations. For example, some embodiments may operate on biweekly periods, while others operate on annual periods.

The present embodiment determines the monthly growth rate of a well and displays it in the “monthly growth rate” field 278. The monthly growth rate of each well may be easily determined from the annual well growth rate specified by the user in the utilization growth field 138, in a manner known to those skilled in the art. Generally speaking, the monthly utilization growth is constant from month to month.

Once the monthly growth rate field 278 is populated, its value may be used to determine the monthly utilization percentage of the well. This value is displayed in the “monthly utilization rate” field 280. As should be appreciated by those skilled in the art, utilization of the well will not begin until the first month of the plant's operation. Accordingly, entries prior to the first month of plant operations (i.e., periods having a zero in the “period from operational” field 272) also have a zero entry in the monthly utilization rate field 280. For the first period in which the plant is operational, the embodiment assigns the initial well utilization value, taken from the initial utilization field 136 of the well characteristics subscreen 124, and assigns it to the utilization rate field 280. For subsequent months (or other periods, in alternative embodiments), the embodiment 100 multiplies the prior month's well utilization rate by the value of the present month's monthly growth rate field 278, and adds it to the prior month's well utilization rate. This iterative process continues for each month/period.

The embodiment 100 may also calculate a number of gallons of contaminated liquid treated in each month. To do so, the embodiment 100 multiplies the present month's utilization rate (shown in the utilization rate field 280) by the number of days in the present month, by value in the gallons per day field 223 of the plant specifications screen 220. The result populates the “gallons treated” field 282. The embodiment may also total the number of gallons treated per month by each well to yield a monthly total.

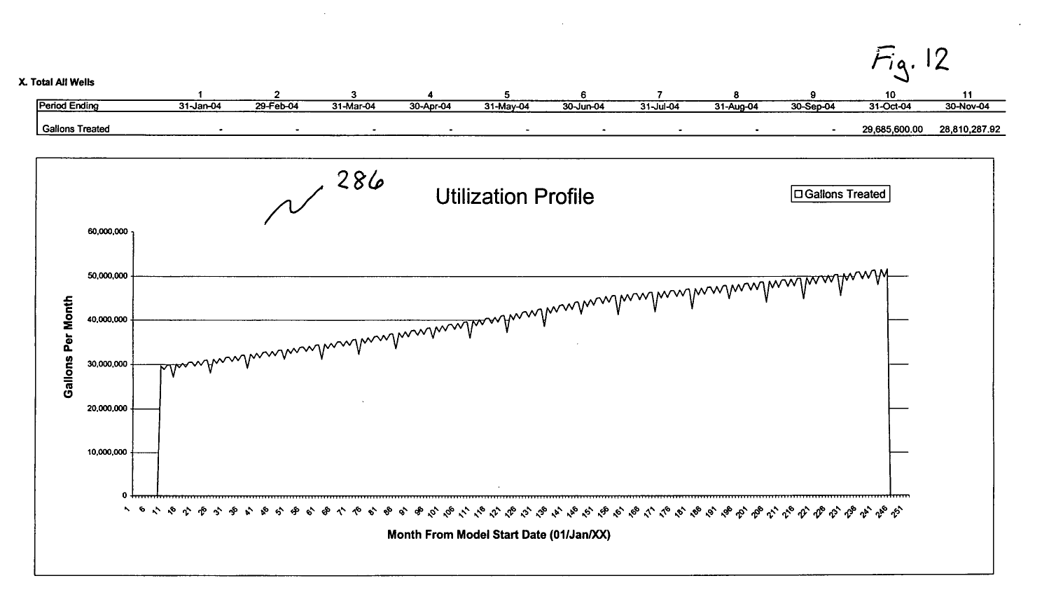

The embodiment may also plot the total number of gallons of contaminated liquid treated in a graph 286, for ease of viewing and for use in trending activities. The data points in graph 286 correspond to the values of the total gallons treated field 284. Alternate embodiments may produce separate graphs showing the monthly gallons treated for each well, or may produce an aggregate graph showing the monthly gallons treated by each well on a single graph. An exemplary graph 286 is shown in FIG. 12.

It should be noted that the number of gallons treated generally trends upward from month to month, since the utilization rate also trends upward. However, slight downticks in terms of gallons treated may be seen in months having thirty days, as opposed to thirty-one days. Thus, the embodiment 100 may forecast the number of gallons of contaminated liquid treated in a sawtooth-type pattern, as shown in graph 286.

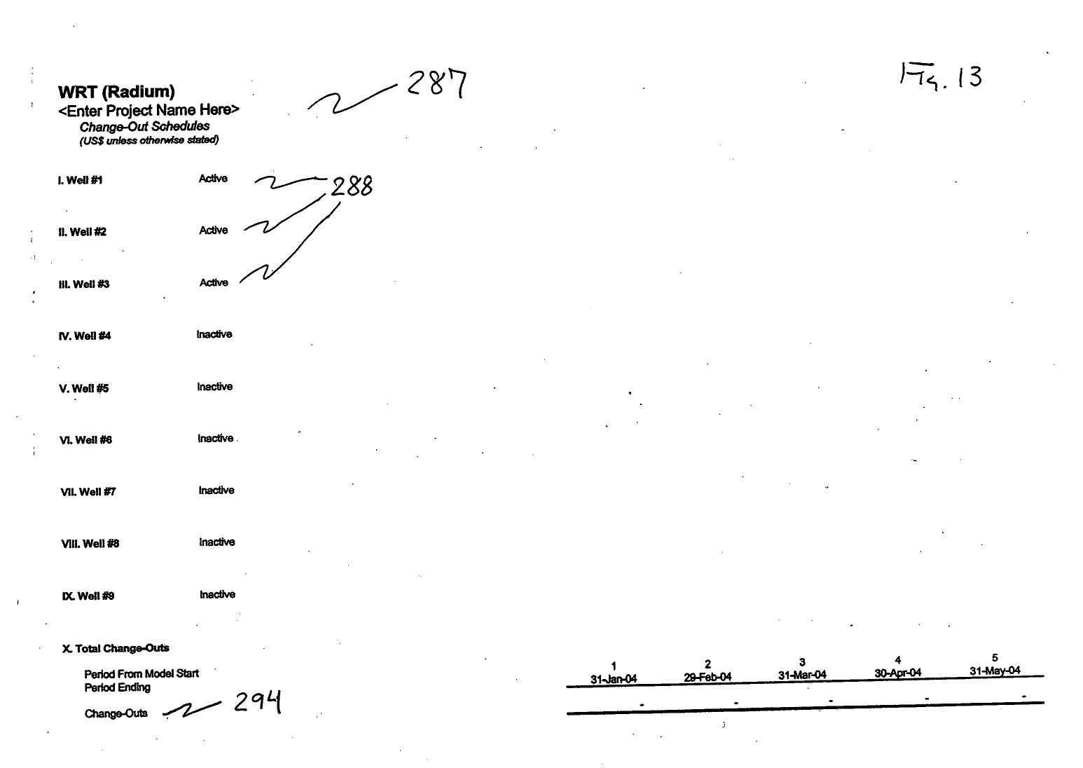

The embodiment 100 also includes a change-out schedule screen 287, depicted in FIG. 13. This screen 287 includes general information related to the times at which the zeolite charges placed within each tank must be refreshed. Refreshing the charges typically requires removing the old, spent zeolite and placing new zeolite in each tank. Thus, the zeolite is periodically changed out.

The change-out screen 287 displays the status of each well in a status field 288, similar to the well activity window 270 discussed with respect to the utilization profile screen. For each well, the number of gallons that may be treated prior to changing out the zeolite charge for a plant is displayed in the “change-out frequency” field 289. This value is taken from the gallons treated at change-out field 266 of the plant specifications screen 220.

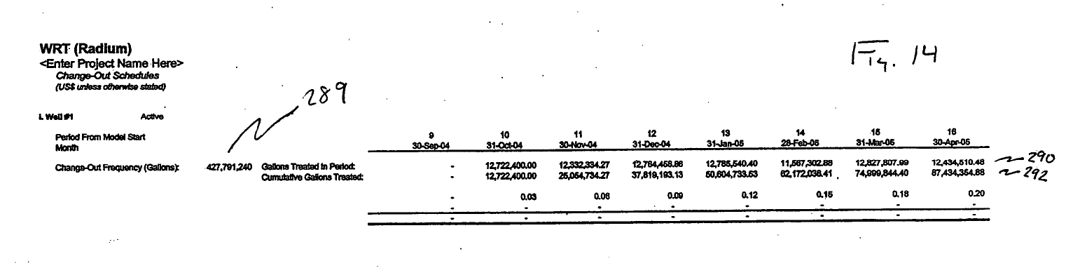

As shown in FIG. 14, each well further has a dedicated series of fields indicating the number of gallons treated in the given period (the “gallons treated in period” field 290), the cumulative number of gallons treated through the end of the given period (the “cumulative gallons treated” field 292), and whether the zeolite in a tank must be changed (the “change-out” field 294). The gallons treated in period field 290 depicts the same value as the gallons treated field 282 of the utilization profile screen 268, for the same month. The embodiment 100 also calculates the cumulative gallons treated from each well by adding the number of gallons treated in the current month (from that month's gallons treated field 282) to the cumulative number of gallons treated in the prior month (from the prior month's cumulative gallons treated field 292). The result is displayed in the current month's cumulative gallons treated field 292.

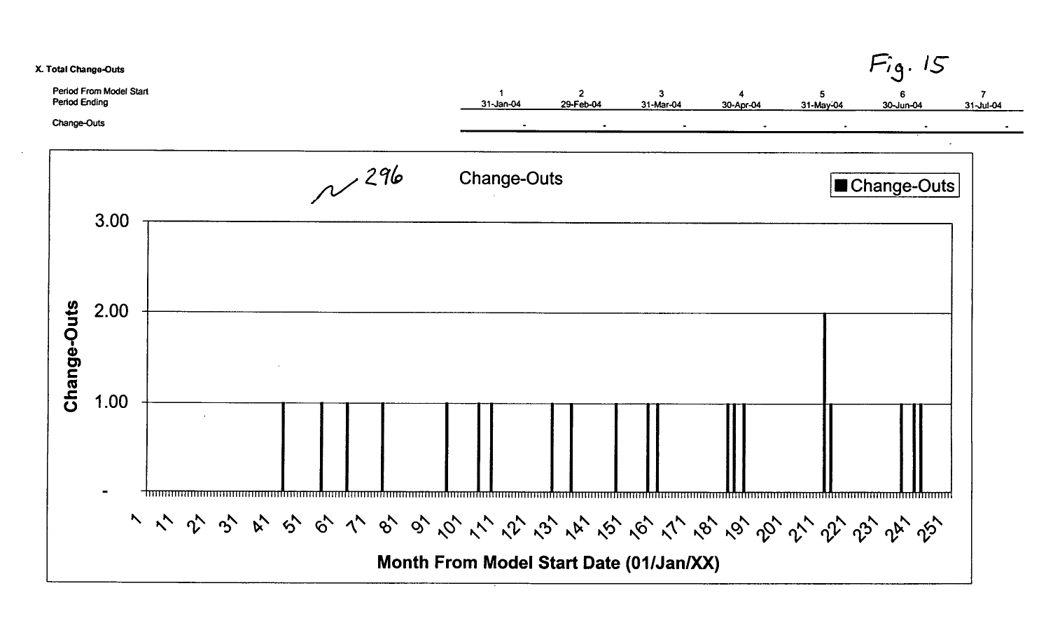

When the value of the cumulative gallons treated field 292 exceeds the value of the change-out frequency field 289, the zeolite charge is spent and must be replaced. Accordingly, a “1” is displayed in the change-out field 294. The data provided in the change-out frequency field 289 may be plotted on a change-out graph 296. An exemplary graph is shown in FIG. 15. The change-out graph 296 generally depicts the number of zeolite charges that must be replaced in each month (or other period).

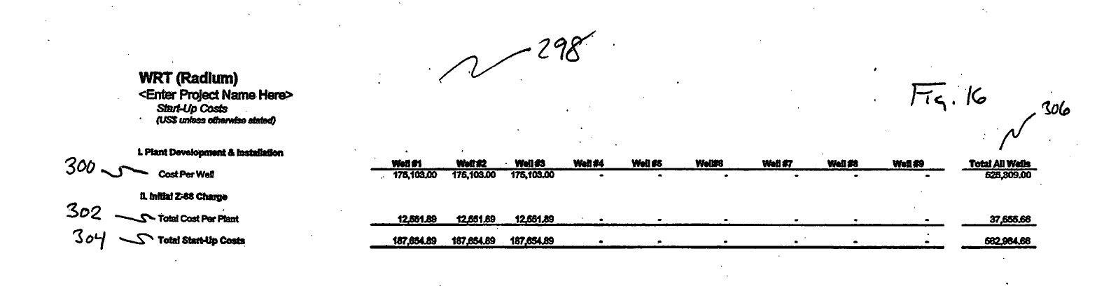

The embodiment 100 also includes a start-up costs screen 298, shown in FIG. 16. The start-up costs screen 298 generally depicts data associated with the start-up of a plant, such as the cost to construct each plant per well, cost for each filtering agent charge, and total start-up costs, on a per-well basis. Each well includes its own column on the screen 298.

For example, the start-up costs screen 298 depicts the cost to construct the plant required to clean each well (i.e., cost per well) in the “cost per well” field 300. The cost per well is determined by taking the cost per plant (inputted in the plant construction cost field 140 of the well characteristics subscreen 124) and adding the materials cost per well, as described above. The sum is displayed in the cost per well field 300.

The cost of the initial zeolite (“Z-88”) charge, per plant, is displayed by the embodiment 100 in the “total cost per plant” field 302. The initial cost of the filtering agent charge is computed as discussed above with respect to the financing assumptions subscreen 186.

The values in the cost per well field 300 and total cost per plant field 302 are summed to yield a total start up cost for each well, which is displayed in the appropriate well column in the “total start-up costs” field 304. The present embodiment 100 not only displays the cost per well, cost of the initial zeolite charge, and total start-up cost for each well, but also for all wells totaled. These values are generally shown in the “total all wells” column 306.

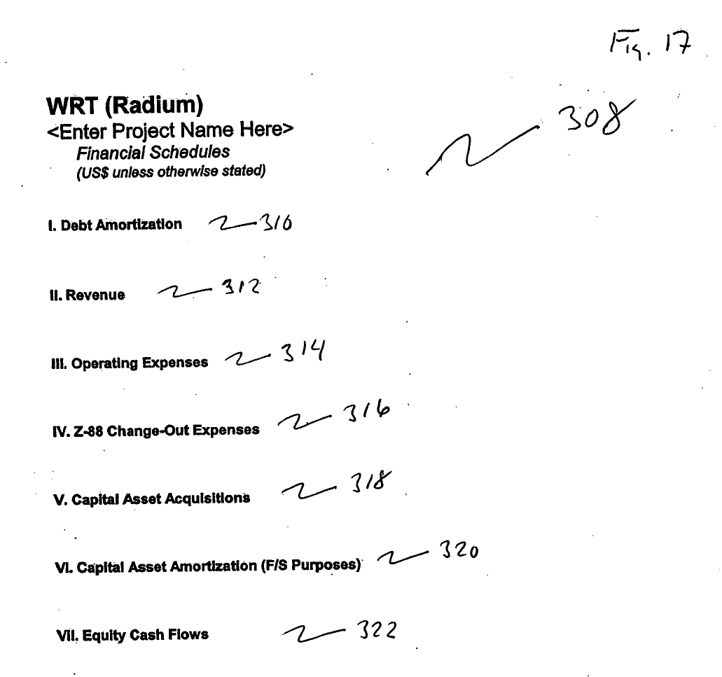

Turning now to FIG. 17, the financial schedules screen 308 is depicted. The financial schedules screen 308 generally depicts data related to the financial operation of the one or more plants created to treat the contaminated liquid. The financial schedules screen 308 generally includes the following subscreens: debt amortization 310, revenue 312, operating expenses 314, change-out expenses 316, capital asset acquisitions 318, capital asset amortization 320, and cash flows 322. Each subscreen will be discussed in turn.

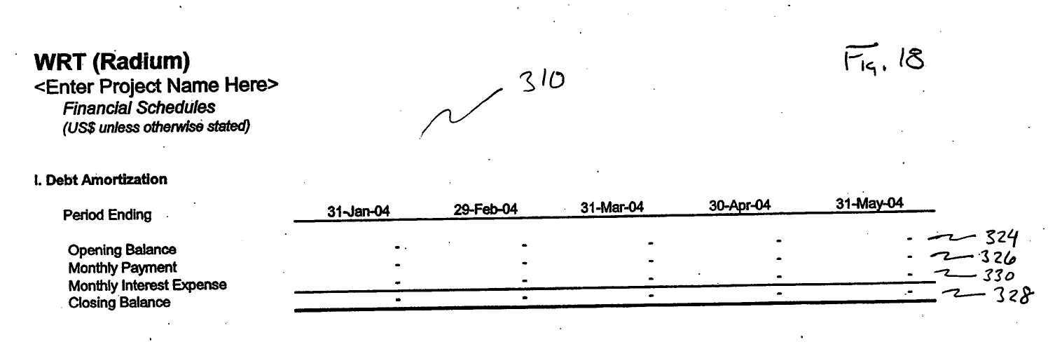

FIG. 18 depicts a portion of a debt amortization subscreen 310. The debt amortization subscreen displays data relating to the amortization of the debt acquired to construct the plant (or plants). The plant construction debt percentage was specified by the user in the percentage debt field 190. The embodiment may calculate the dollar value of the debt from the percentage debt and the total start-up cost (displayed in the total start-up financing field 192 of the financing assumptions subscreen 186). The present embodiment employs the debt term and interest rate specified in the debt term field 202 and interest term field 204, respectively, to calculate a monthly debt payment.

The initial total debt financed is depicted in the “opening balance” field 324, in the column corresponding to the period in which the plant becomes operational. For example, if the user specified the plant would become operational in October 2004 in the plant operational field 118, the total debt financed would show in the opening balance field 324 for the month of October 2004. All months (or other periods, in other embodiments) prior to October 2004 would have no balance.

The amount of the monthly payment calculated by the embodiment 100 is shown in the “monthly payment” field 326. Again, the first month to show a monthly payment is typically the month in which the plant becomes operational. The monthly debt payment is subtracted from the debt balance (shown in the “opening balance” field 324 for that month), and the result displayed by the embodiment 100 in the “closing balance” field 328.

Some portion of the monthly debt payment represents interest paid on the debt. The embodiment 100 calculates this portion (again, using the user-specified debt term and interest rate) and depicts the interest portion in the “monthly interest expense” field 330.

Periods following the period in which the plant becomes operational depict the remaining debt financed in the corresponding opening balance field 324. That is, each period depicts the prior month's closing balance in its opening balance field 324.

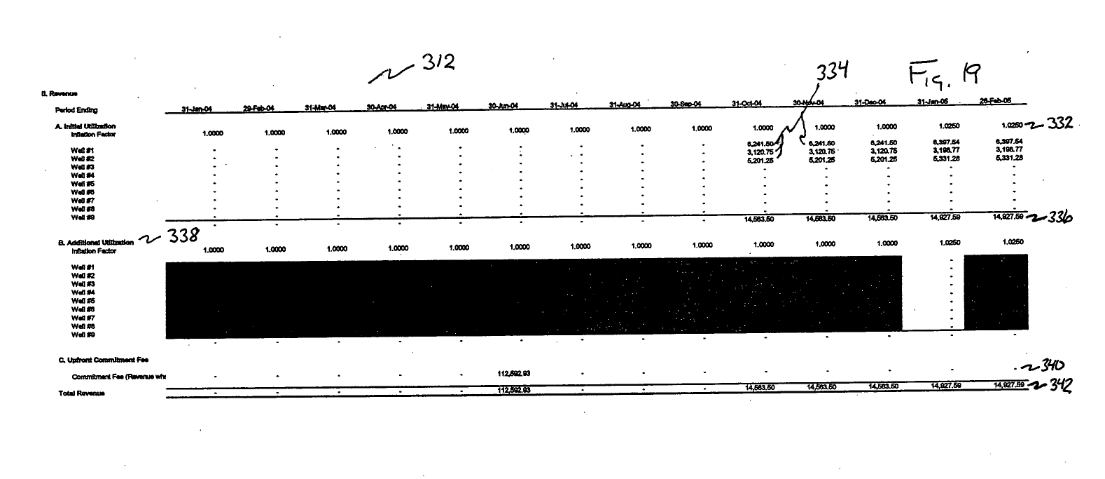

FIG. 19 depicts the revenue subscreen 312. The revenue subscreen 312 provides indications regarding the revenue generated by each well during the period in question. Initially, the embodiment displays the inflation factor for each month in the “inflation factor” field 332. The inflation factor is taken from the rate specified by the user in the price indexation base field 160 of the revenue assumptions subscreen 156. The embodiment may calculate a monthly variance for the inflation factor to take into account the user-specified inflation rate, inputted in the inflation rate field 161 of the revenue assumptions subscreen 156. Generally, the embodiment calculates the monthly inflation rate from the yearly, user-specified inflation rate, and applies the monthly rate to determine the monthly inflation factor. The embodiment may set the inflation factor for each month of a given year equal to one another, or may vary the inflation factor for each month of a year. In either regard, however, the inflation factor for the first month of the subsequent year equals the prior year's inflation factor, multiplied by the user-specified inflation rate from the inflation rate field 161.

Also shown on FIG. 19 is the revenue generated by each active well. Each well has a dedicated row, while each month (or other period) has a dedicated column. The intersection of the row and column defines a utilization revenue field 334. The utilization revenue field 334 indicates the revenue expected from the well in question, for the period in question.

Each well's revenue may be calculated by the present embodiment 100. Beginning with the month in which the plant becomes operational, the embodiment 100 determines a base monthly charge (revenue) the operator may levy against the well owner, for each well. The charge is determined by computing an monthly base volume of well liquid treated by the plant. The embodiment 100 may, for example, take the value in the gallons treated per day field 264 of the plant specifications screen 220 and determine an annual number of gallons treated. Since the user specified a price charged per thousand gallons treated in the utilization price field 158 in the revenue assumptions subscreen 156, the annual charge levied by the operator on the well owner may be easily determined. The price per thousand gallons is multiplied by the annual number of gallons treated, and the product is divided by 1000. This yields the annual well charge.

The annual well charge may be divided by twelve to estimate the base monthly charge (i.e., revenue) per well. Alternately, the annual well charge may be divided by 365, and multiplied by the number of days in each month to calculate a base monthly charge for a given month. Regardless, the base revenue for each well in a given month is displayed in the utilization revenue field 334.

The embodiment 100 may also take the inflation rate into account when determining the base revenue per well. Each year, the inflation factor rises as discussed above. The base monthly charge determined for the last month of a given year is generally multiplied by the inflation factor for the subsequent year to yield the base monthly charge/revenue of the well in the subsequent year. Thus, each year generally sees the revenue generated by the well rise by the amount of the inflation rate.

The embodiment 100 may provide monthly total revenues for each operational well in the “monthly revenues” field 336.

Similar calculations to those immediately discussed may be performed by the embodiment to determine additional revenue due to yearly additional utilization of each well. The additional revenue is displayed in the “additional utilization” field 338 for each well, under the subheading “B. Additional Utilization.”

The embodiment 100 may also depict the upfront commitment fee required when plant construction begins. This value is shown in the “commitment fee” field 340, and is taken from the upfront commitment field 168 of the revenue assumptions subscreen 156.

Finally, the embodiment may total the revenue for each month (or other period) and display the total in the appropriate column's “total revenue” field 342.

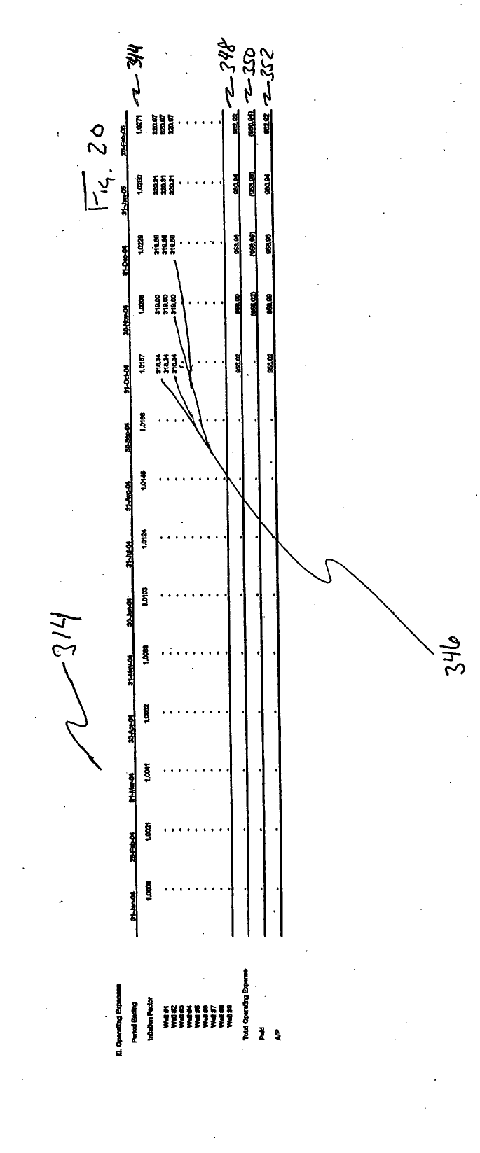

Turning now to FIG. 20, the embodiment 100 also includes an operating expenses subscreen 314. As with prior subscreens of the financial schedules screen 308, the present subscreen 314 includes a table, where each well corresponds to a row and each period a column. The operating expenses subscreen also displays an inflation factor in an inflation factor field 344, which in the present embodiment 100 varies by period. The inflation factor is generally calculated in a manner similar to that described above.

The intersection of each well's row and each period's column defines an “expenses” field 346 for the well during the period. Expenses are generally not incurred until the plant becomes operational. The embodiment 100 determines each month's expense per well by multiplying that month's inflation factor by the monthly cost of the well. A well's monthly cost may be calculated by dividing the value shown in the cost per plant field 180 of the cost assumptions subscreen 172 by 12.

The monthly cost for all wells is summed to yield a total operating expense, displayed in the “total operating expense” field 348.

Typically, the operating expense for a given month is paid in the subsequent month. Accordingly, the “paid” field 350 for each month (or other period) shows the value of the prior month's total operating expenses. The accounts payable field 352 for each month displays the sum of the current month's operating expense, plus the accounts payable for the prior month, les the amount paid in the present month.

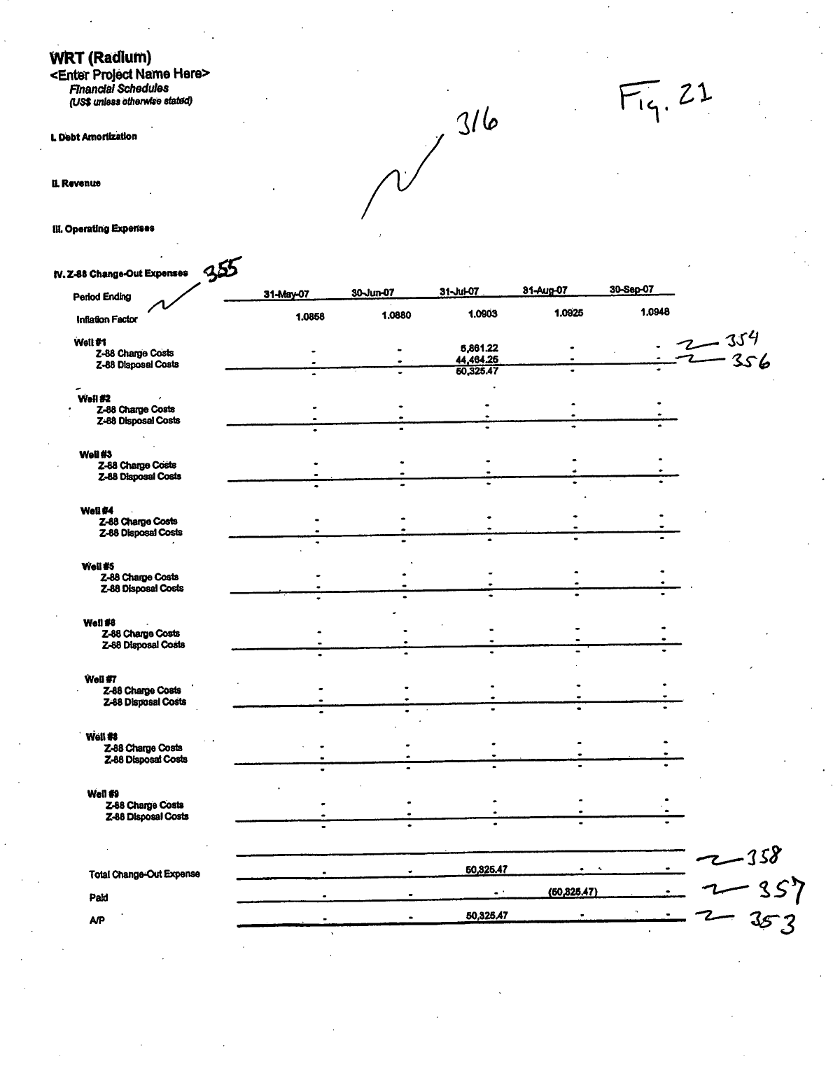

FIG. 21 depicts the change-out expenses subscreen 316. As with prior subscreens, the inflation factor 355 is shown on the change-out expenses subscreen 316. As discussed above with respect to the change-out schedule screen 286, the embodiment 100 may determine specific periods during which the filtering agent in each tank must be changed. It should be noted that each well may require the associated filtering agent be changed in different periods.

In a period during which the filtering agent must be changed for a well, the embodiment 100 computes the expenses associated with the change-out. The cost of a fresh filtering agent charge is first determined. The number of tons of filtering agent required per tank is multiplied by the cost per ton of the filtering agent, to arrive at a fresh materials cost for the agent. A shipping cost is added thereto. The shipping cost is determined by multiplying the shipping cost per mile to by the number of miles between the supply point and the plant's location. Derivation of both the materials cost and shipping cost is discussed in more detail above with respect to the financing assumptions subscreen 186. The shipping cost plus the fresh materials cost is multiplied by the period's inflation factor to yield the cost of a fresh charge, displayed in the “charge costs” field 354.

The embodiment 100 may also determine costs associated with disposing of the spent filtering agent. This cost is generally shown in the “disposal costs” field 356, and is calculated as follows.

First, the following values are added together to determine a base disposal cost: the assay cost per load of filtering agent, any state fees levied on the filtering agent, the materials cost for each active well (as discussed with respect to the financing assumptions subscreen 186, above), any disposal costs charged by the disposal site (such as labor and/or bagging), the labor cost to remove the filtering charge at the plant site, and the volume fees levied by the disposal site on the filtering agent being disposed. Disposal site fees vary from site to site. For example, Hanford typically charges $61.25 per cubic foot of material accepted, Grandview charges $12.03 per cubic foot, and Newpark $35.00 per cubic foot. The price per cubic foot may be converted into a price per ton to determine the fees levied by the disposal site on the tonnage of filtering agent being changed out.

Similarly, certain sites may charge for labor and disposal bags. Hanford, for example, charges such fees, while Grandview does not.

The assay cost per load and state fees are typically constants, and may be specified by a user of the invention or assumed by the embodiment 100. Calculation of the materials cost per well was discussed in greater detail above, with respect to the financing assumptions subscreen 186.

The base disposal cost is multiplied by the inflation factor for the period in which the change-out occurs to yield a final disposal cost. This disposal cost is shown in the disposal costs field 356.

The sum of the charge and disposal costs yields a total change out cost for each well. The sum of the total change out costs for all wells is shown in the “total change-out expense” field 358.

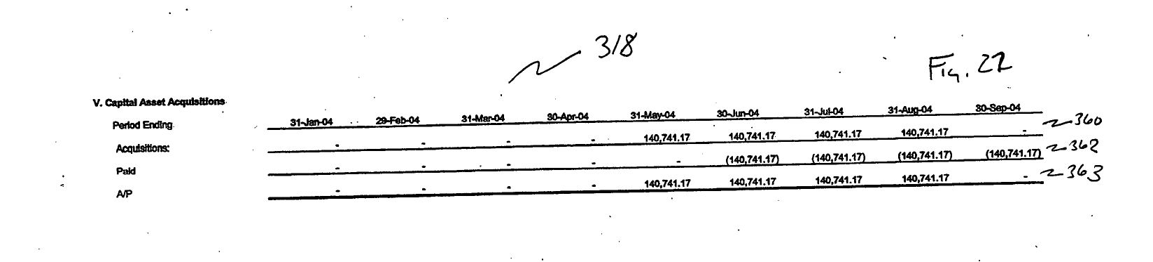

FIG. 22 shows the capital asset acquisitions subscreen 318. Capital asset acquisitions occur from the period in which construction begins to the period in which construction halts. The total start-up costs (shown in the total start-up costs field 304 of the start-up costs screen 298) is divided by the number of periods occurring from the time construction starts to the time construction ends. The resulting value is depicted in the acquisitions field 360 for each period during which construction occurs.

Typically, the cost of a given period's acquisition is paid in the subsequent period. Accordingly, the acquisition cost for a given month is shown as a payment in the subsequent month's “asset paid” field 362. Accounts payable for asset acquisitions may be calculated by adding a previous period's accounts payable balance (shown in the “A/P” field 363) to the value of the present period's acquisitions field 360, and adding the payment in the present period's asset paid field 362. The payment in the asset paid field is depicted as a negative value, and accordingly is added to the other two values. The result is displayed in the present period's A/P field 363.

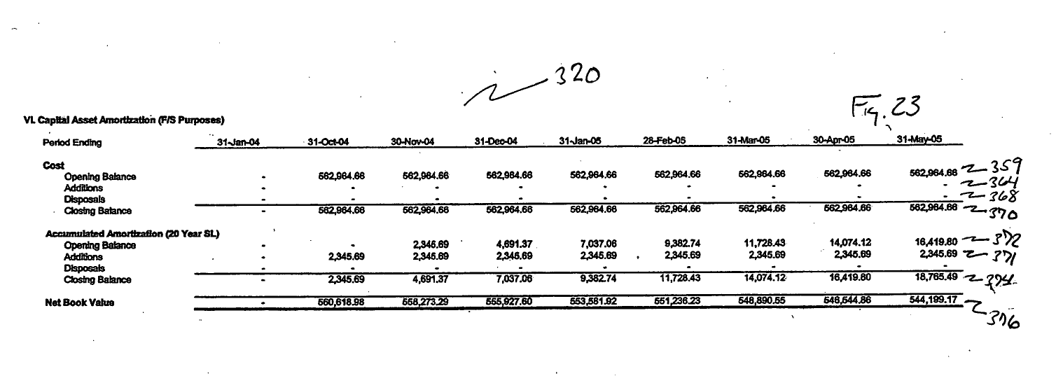

The financial schedules screen 308 includes the capital asset amortization subscreen 320, shown in FIG. 23. Each period's opening balance is displayed in the “opening balance” field 359, and is equal to the prior period's closing balance. The value of the acquisitions field 360 is repeated in the “additions” field 364. The embodiment 100 may also depict the value of any asset disposals in the “disposals” field 368. A period's closing balance equals the sum of its opening balance, additions, and disposals, and is shown in the cost “closing balance” field 370. In the present embodiment 100, disposals are generally negative numbers.

The present embodiment 100 may also calculate accumulate amortization for the plant, which does not begin until the plant is operational. In the first period in which the plant is operational, the value of the “accumulated opening balance” field 372 is zero. Since amortization is calculated in the present embodiment on a twenty-year term, amortization accrues for each month of the plant's operation in an amount equal to the value of the cost closing balance field 370, in the month the plant becomes operational, divided by 240 (the number of months in twenty years). This value is shown in the “amortization additions” field 371. A period's opening amortization balance, plus any amortization additions and amortization disposals, yields the amortization closing balance. The amortization disposals and amortization closing balance are set forth in the amortization disposals field 375 and amortization closing balance field 374, respectively.

The amortization opening balance for any given period is the amortization closing balance of the prior period.

The embodiment 100 may also calculate a net book value for any and all periods; this value is displayed in the “net book value” field 376. The net book value equals the cost closing balance 370 minus the amortization closing balance 374.

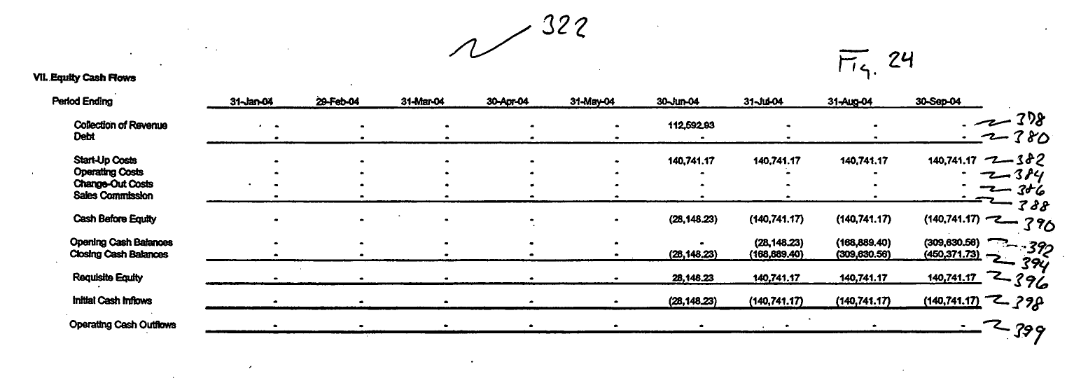

The final subscreen of the financial schedules screen 308 is the cash flows subscreen 322, shown generally in FIG. 24. For each period, the revenue collected is shown in the “collection of revenue” field 378, and debt is shown in the “debt” field 380. Start-up costs for the period are shown in the “cash flows start-up costs” field 382, and are copied from the “paid” field 362 of the capital asset acquisitions subscreen 318. Operating costs are shown in the “cash flows operating costs field” 384, and are taken from the paid field 350 of the operating expenses subscreen 314. Change out costs, shown in the “cash flows change out costs” field 386, are taken from the paid field 357 of the change-out expenses subscreen 316.

Any sales commission paid on the contract is shown in the sales commission field 388, and is typically paid in the month the plant becomes operational. The sales commission may be calculated from the value in the sales commission field 170 of the cost assumptions subscreen 172 and the sum of the annual well charges for each operating well.

Cash before equity for each month equals the sum of the collection of revenue field 378 and debt field 380, less the sum of the cash flows start-up costs field 382, cash flows operating costs field 384, cash flow change-out costs field 386, and sales commission field 388. The cash before equity for each month is displayed in the relevant “cash before equity” field 390.

The “opening cash balances” field 392 displays the value of a period's opening cash balance, and is equal to the previous period's closing cash balance.

The “closing cash balances” field 394 equals the value of a given period's closing cash balance, and equals the value of the opening cash balances field 392 for the period plus the value of the cash before equity field 390 for the period.

The values of the “requisite equity” field 396 and “initial cash inflows” field 398 may be calculated as known to those skilled in the art.

Finally, the value of each period's “operating cash outflows” field 399 equals the value of the period's cash before equity field 390, so long as the plant is operational.

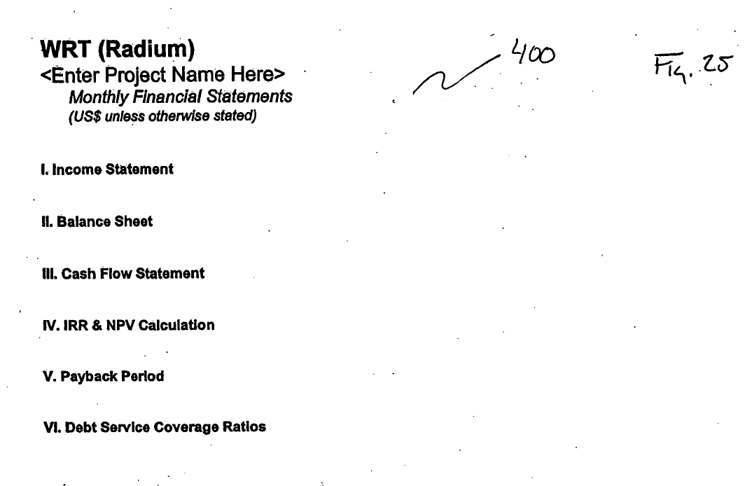

FIG. 25 depicts the monthly financial statements screen 400 of the present embodiment 100. This screen 400 is divided into six subscreens, each of which will be discussed in turn. Certain views in FIGS. 25-29 have had the columns of various tables compressed to show a greater variety of data. It should be noted, however, that the present embodiment 100 may generate tables without such compression.

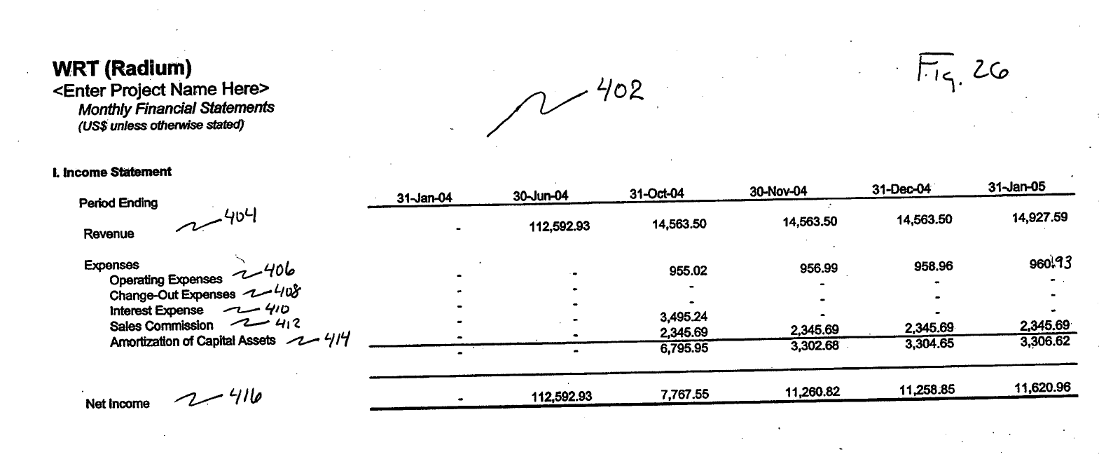

FIG. 26 depicts the income statement subscreen 402. The income statement subscreen includes a table having columns corresponding to months. Each month includes a revenue field 404, operating expenses field 406, change-out expenses field 408, interest expense field 410, sales commission field 412, amortization of capital assets field 414, and net income field 416.

The revenue field 404 displays the value of the total revenue field 342 for the given period. The total revenue field 342 is located on the revenue subscreen 312 of the financial schedules screen 308.

Similarly, each of the various expense fields reflects a value of a field, in a given period, as discussed elsewhere herein. The operating expenses field 406 mirrors the value of the given period's total operating expenses 348 on the operating expenses subscreen 314. The “change-out expenses” field 408 value is taken from the total change-out expenses field 358 on the change-out expenses subscreen 316. The value of the “interest expense” field 410 is taken from the monthly interest expense field 330 of the financial schedules screen. The “sales commission” field 412 value is computed as discussed above with respect to the sales commission field 388 of the financial schedules screen. Finally the value shown in the “amortization of capital assets” field 414 is copied from amortization additions field 371.

The embodiment 100 calculates net income subtracting the values of each expense field 406, 408, 410, 412, 414, from the value of the revenue field 404. The result for each month is displayed in the “net income” field 416.

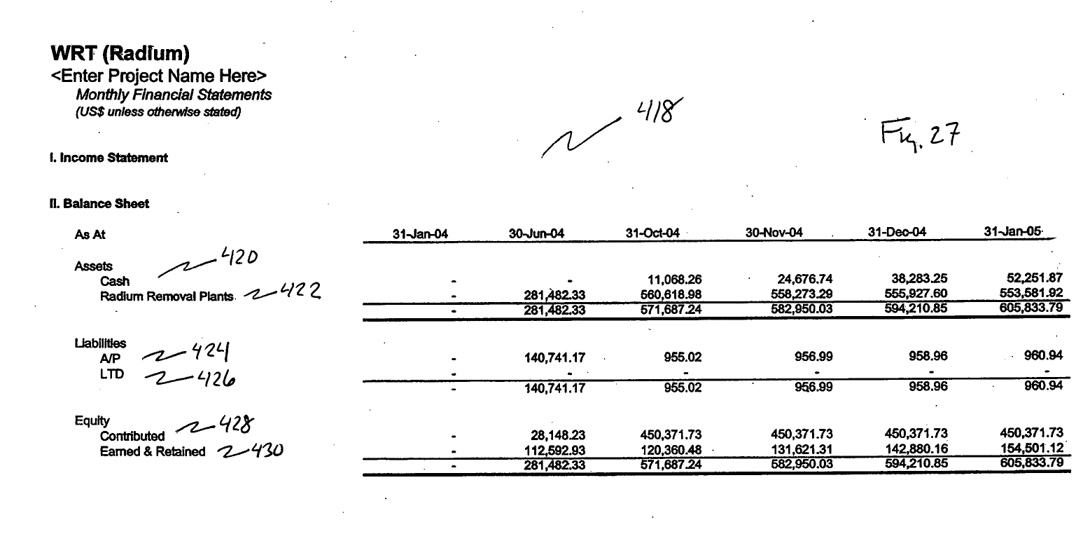

FIG. 27 generally depicts the balance sheet subscreen 418 of the monthly financials screen 400. The balance sheet lists, for each month, assets and liabilities. Assets generally include cash and plant values, while liabilities include accounts payable and long-term debt. The value in the “cash” field 420 is the net cash flow, which equals the cash before debt service, plus any debt service. The value in the “removal plants” field 422 is taken from the net book value field 376 of the financial services screen.

Similarly, the value in the “A/P” field 424 represents the accounts payable balance in the given period, and equals the sum of the values in the accounts payable field 352 of the operating expenses subscreen 314, the accounts payable field 353 of the change-out expenses subscreen 316, and the A/P field 363 of the capital asset acquisitions subscreen 318.

The value shown in the “LTD” (“long-term debt”) field 426 equals the value of the same period's closing balance field 328 on the debt amortization subscreen 310.

The balance sheet subscreen also shows the value of equity contributed (in the “equity contributed” field 428) and equity earned and retained (in the “equity earned and retained” field 430). Contributed equity for a month equals the previous month's contributed equity, plus any equity inflows for the month in question. Equity earned and retained equals the previous month's earned and contributed equity, plus the present month's net income.

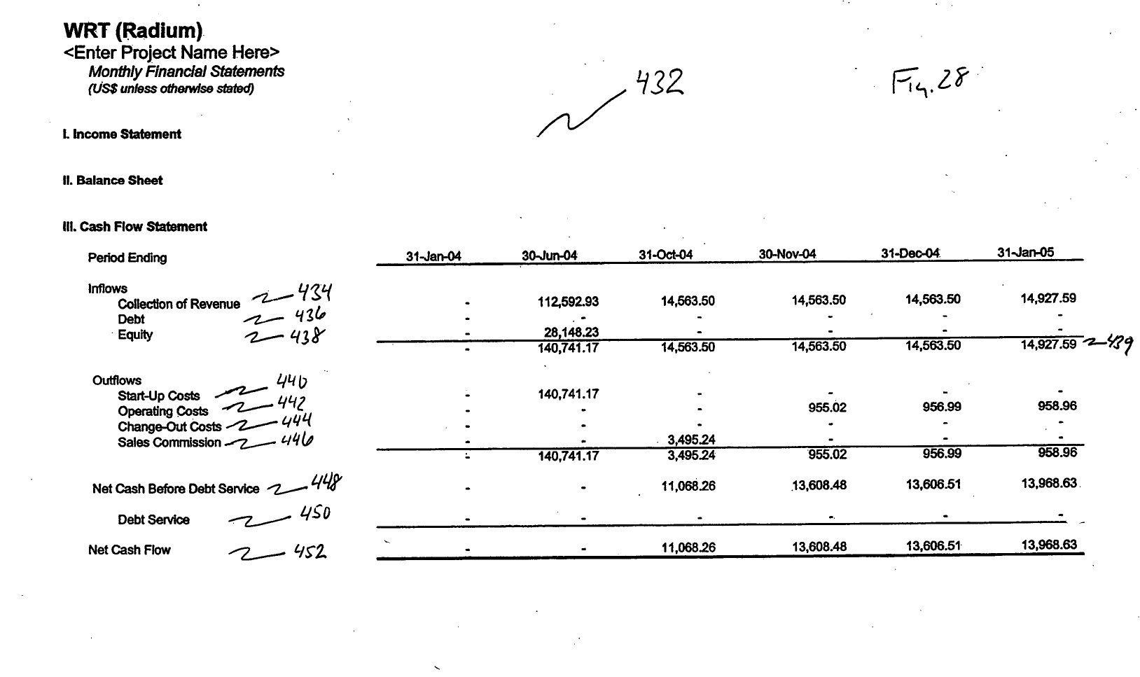

FIG. 28 generally depicts the cash flow statement subscreen 432 of the monthly financials screen 400. The embodiment 100 may calculate the collection of revenue (shown in the revenue field 434), debt (shown in the debt field 436 and taken from the opening balance field of the debt amortization subscreen 310), and equity (shown in the equity field 438 and equal to the value of the requisite equity field of the equity cash flows subscreen 322) for a given month. The sum of these three fields yields the total cash inflow, shown in the total inflow field 439.

Similarly, the present embodiment 100 may calculate all outflows for a given period. Outflows include start-up costs (shown in the “start-up costs” field 440 and the inverse of the value in the paid field 362 of the capital asset acquisitions subscreen 318), operating costs (shown in the “operating costs” field 442 and the inverse of the value in the paid field 350 of the operating expenses subscreen 314), change-out costs (shown in the “change-out costs” field 444 and the inverse of the paid field 357 of the change-out expenses subscreen 316), and any sales commission (shown in the “sales commission” field 446 and previously discussed).

The present embodiment may calculate the net cash before debt service, displayed in the “net cash before debt service” field 448, by subtracting total cash outflow from total cash inflow. The embodiment may also display in the “debt service” field 450 the value, for the same period, of the “monthly payment” field of the debt amortization subscreen 310.

Finally, with respect to the cash flow statement subscreen, the embodiment may calculate net cash flow (shown in the “net cash flow” field 452) by adding the value in the debt service field to the value in the net cash before debt service field.

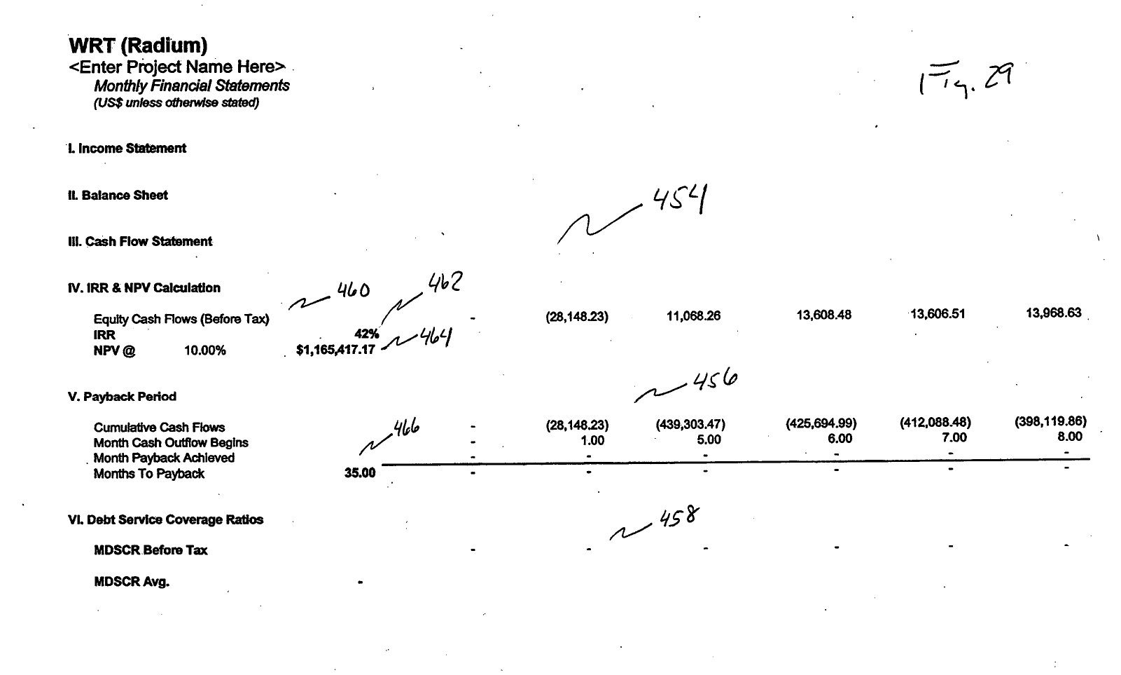

FIG. 29 depicts the IRR & NPV Calculation subscreen 454, Payback Period subscreen 456, and Debt Service Coverage Ratios subscreen 458. The IRR & NPV subscreen generally shows the pre-tax equity cash flows for each month in the “equity cash flows” field 460, as well as the internal rate of return (IRR) 462 on the amount invested in construction of the plant. The embodiment calculates the internal rate of return and net present value in manners known to those skilled in the art. The results are displayed in the “IRR” and “NPV” fields 462 and 464, respectively, The net present value employs the user-specified rate in the NPV field 212 of the project metrics subscreen 206 to determine the net present value.

The embodiment 100 may also calculate the number of months until the initial investment in the plant is paid back, as known to those skilled in the art. This value is shown in the “months to payback” field 466 of the payback period subscreen 456.

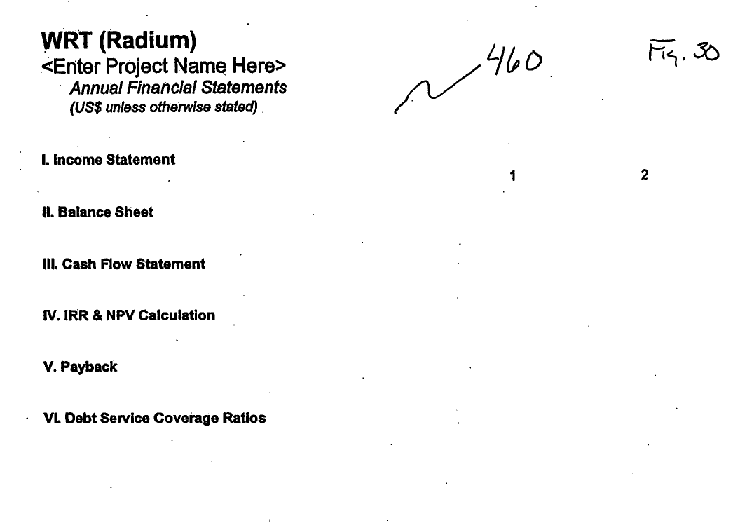

FIG. 30 depicts the annual financial statements screen 460 of the present embodiment 100. This screen 460 is divided into six subscreens, namely the annual income statement, annual balance sheet, annual cash flow statement, annual IRR & NPV calculation, annual payback and annual debt service coverage ratio subscreens. Each subscreen generally corresponds to the subscreen of the same name associated with the monthly financial statements screen 400.

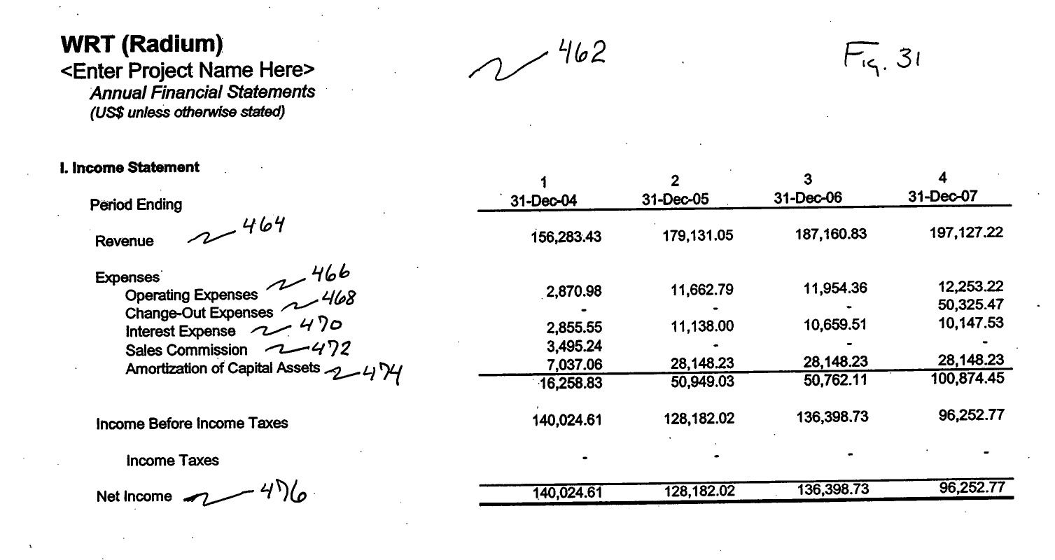

FIG. 31 depicts the annual income statement subscreen 462. The income statement subscreen includes a table having columns corresponding to years. Each year includes a revenue field 464, operating expenses field 466, change-out expenses field 468, interest expense field 470, sales commission field 472, amortization of capital assets field 474, and net income field 476. The calculation of the various data and fields in this subscreen generally parallels the calculations discussed above with respect to the monthly income statement subscreen 402 except that the period in question is a year instead of a month.

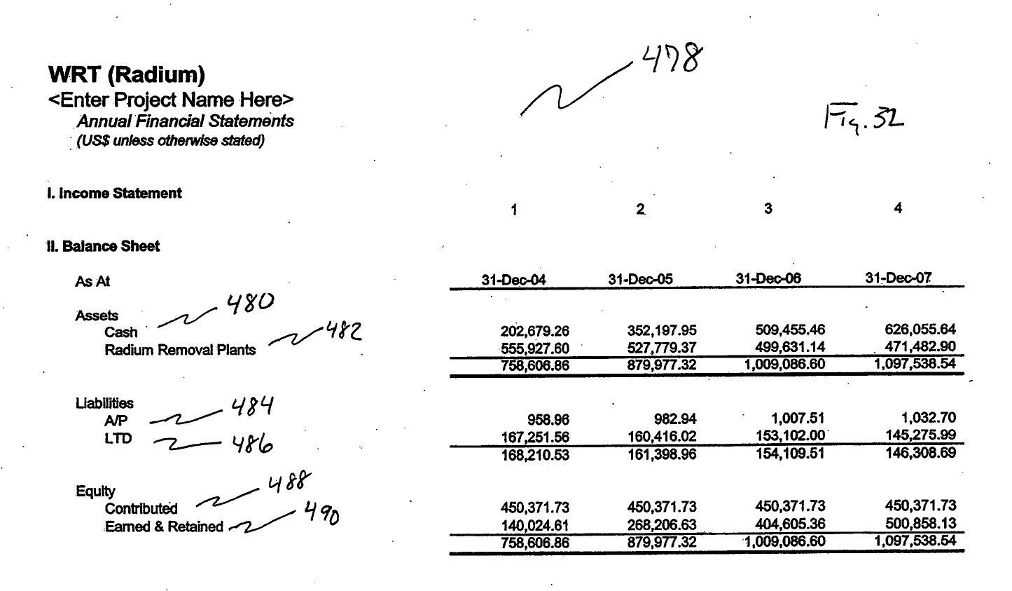

FIG. 32 generally depicts the annual balance sheet subscreen 478 of the annual financials screen 460. The annual balance sheet subscreen has a cash field 480, removal plants field 482, an A/P field 484, a LTD field 486, an equity contributed field 488 and equity earned and retained field 490. The calculation of the various data and fields in this subscreen generally parallels the calculations discussed above with respect to the monthly balance sheet subscreen 418 except that the period in question is a year instead of a month.

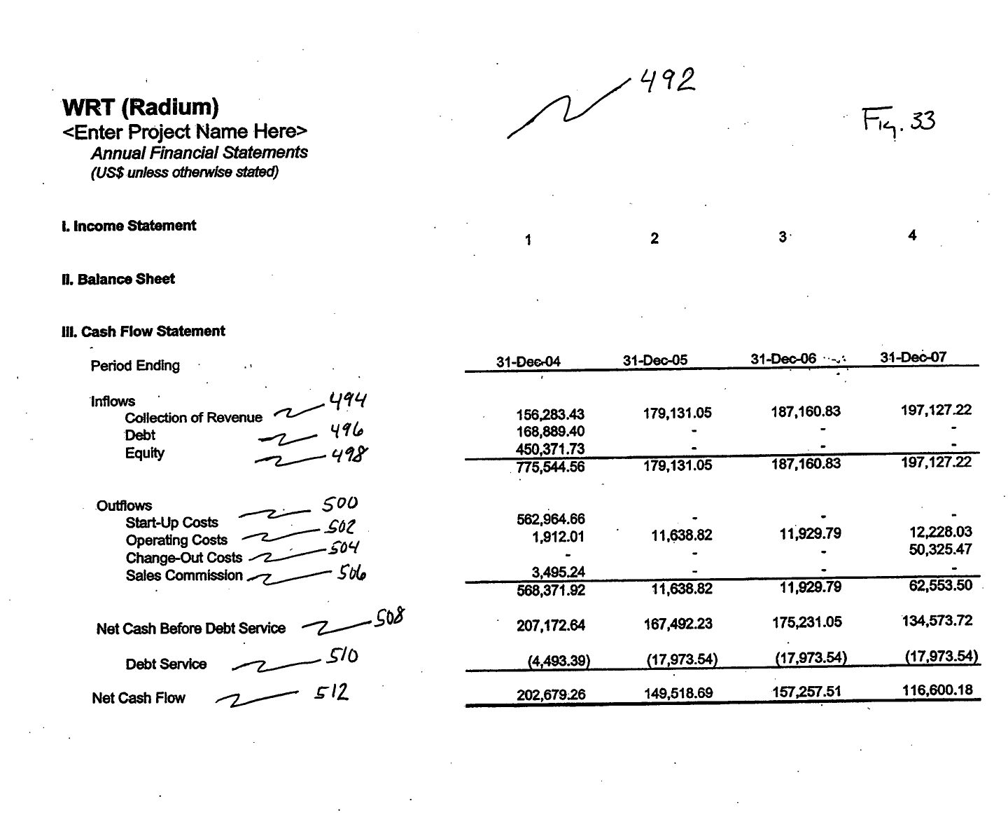

FIG. 33 generally depicts the annual cash flow statement subscreen 492 of the annual financials screen 460. The annual cash flow statement subscreen has a collection of revenue field 494, debt field 496, equity field 498, start up costs field 500, operating costs field 502, change-out costs field 504, sales commission field 506, net cash before debt service field 508, debt service field 510 and a net cash flow field 512. The calculation of the various data and fields in this subscreen generally parallels the calculations discussed above with respect to the monthly cash flow statement subscreen 432 except that the period in question is a year instead of a month.

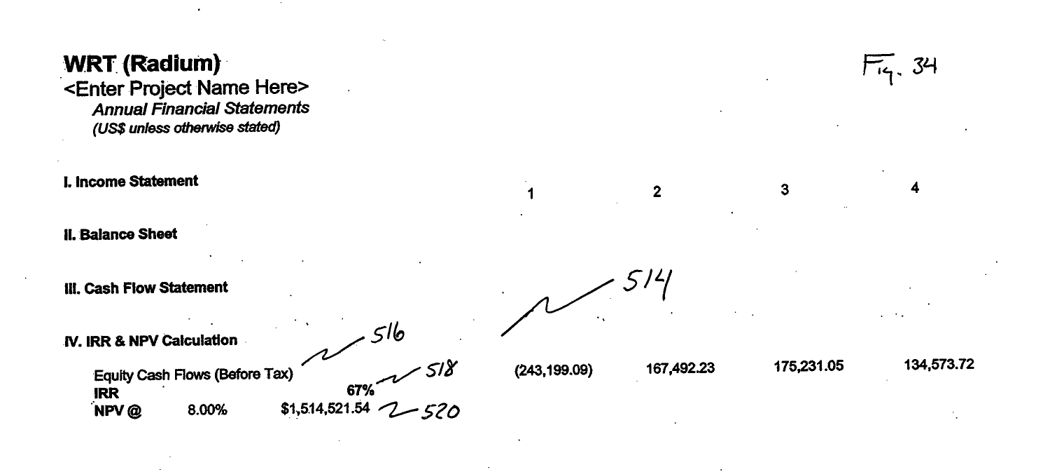

FIG. 34 depicts the annual IRR & NPV Calculation subscreen 514 of the annual financials screen 460. This subscreen generally shows the pre-tax equity cash flows for each year in the “equity cash flows” field 516, as well as the internal rate of return (IRR) 518 on the amount invested in construction of the plant. The embodiment calculates the internal rate of return and net present value in manners known to those skilled in the art. The results are displayed in the “IRR” and “NPV” fields 518 and 520, respectively. The net present value employs the user-specified rate in the NPV field 212 of the project metrics subscreen 206.

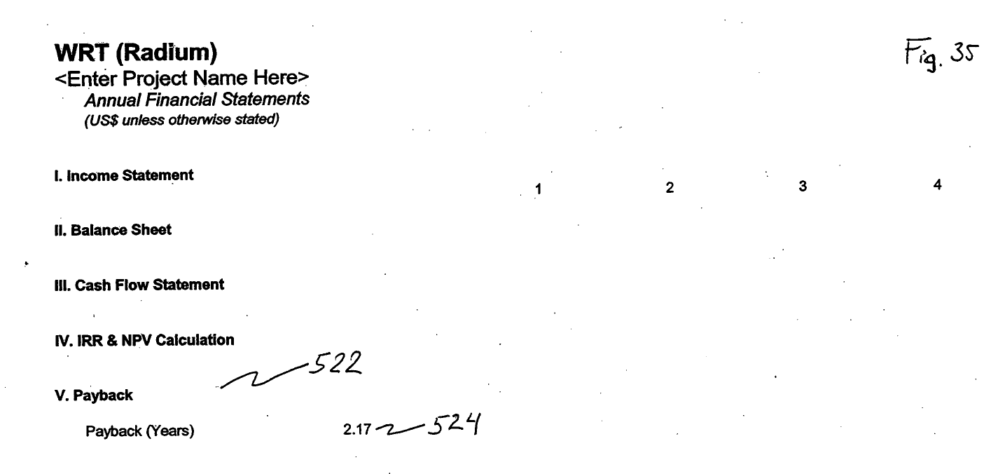

FIG. 35 depicts the annual Payback Period subscreen 522 of the annual financials screen 460. The embodiment 100 may calculate the number of years until the initial investment in the plant is paid back, as known to those skilled in the art. This value is shown in the payback field 524.

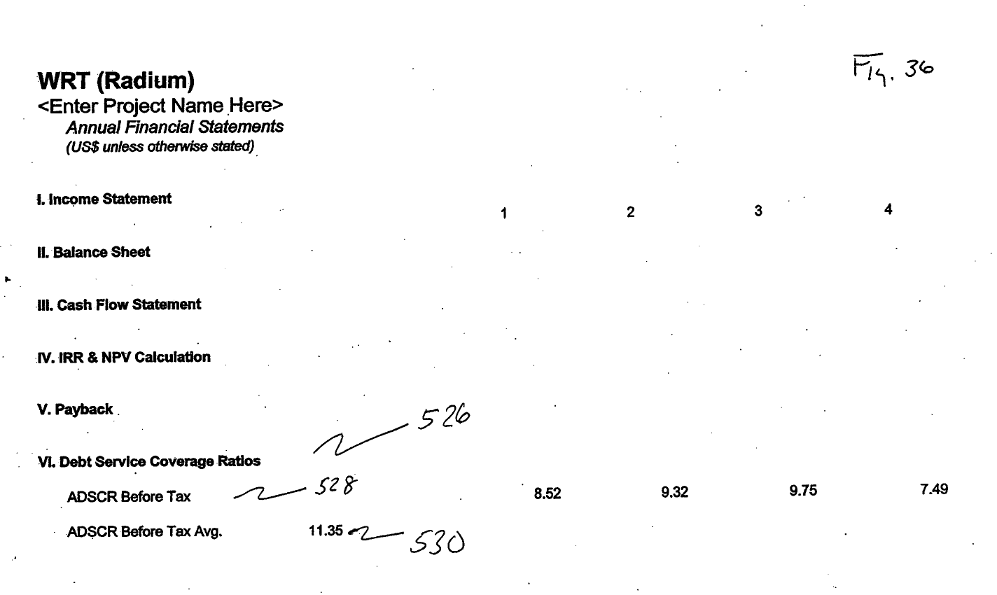

FIG. 36 depicts the annual Debt Service Coverage Ratios subscreen 526. The embodiment 100 may calculate the average debt service coverage ratio (ADSCR) before tax on a yearly basis, as known to those skilled in the art. These results are displayed in the ADSCR Before Tax field 528. The embodiment calculates the average ADSCR before taxes and displays the result in the ADSCR Before Tax Average field 530.

The methods and systems described herein may be implemented as software, hardware, or a combination of the two. The various processes, calculations, and operations disclosed herein may be performed, for example, by a software program and/or component modules configured to execute these procedures, or a hardware system likewise configured. For example, the various inputs discussed herein may be collected by an input module, calculations and other operations carried out by one or more computation modules, and results displayed by a display module, where each module is a software element. It should be noted that one software element may perform multiple procedures, or the various procedures and operations may be split between multiple modules. Further, it should be understood that the implementation of the herein-described methods, systems and operation is but one implementation of the inventions disclosed in this disclosure. Alternative implementations will occur to those of ordinary skill in the art upon reading this disclosure.

Although the present embodiment has been described with particular reference to certain methods and apparatuses, one skilled in the art will appreciate additional advantages upon reading the present disclosure. Further, certain changes and adjustments may be made to the embodiments discussed herein without departing from the spirit or scope of the invention. For example, certain embodiments may be configured to calculate costs and profits associated with the filtering of uranium, cesium, or other contaminants from groundwater or other liquids. Accordingly, the scope and spirit of the invention embraces many variants not explicitly disclosed herein.

What is claimed is:

1. A method for calculating a cost associated with disposal of a substance, comprising:
accepting a plurality of data inputs related to a disposal plan for a radioactive substance;
calculating the cost associated with the disposal plan of the substance; and
generating a financial schedule.

2. The method of claim 1 further comprising generating a plant specification, from the plurality of data inputs, for a plant to filter contaminated water from at least one well.

3. The method of claim 1 wherein the plurality of data inputs comprises at least a substance specification, a substance location, and a disposal location.

4. The method of claim 1 wherein the operation of generating a periodic financial schedule comprises generating operating expenses, change out expenses, income statement, balance sheet, and cash.

5. The method of claim 1, wherein the radioactive substance is one of uranium, strontium, cesium, radium, and irradiated zeolite.

6. The method of claim 1, further comprising amortizing the cost in the financial schedule.

7. The method of claim 3 wherein the data input screen comprises:
a location subscreen;
a well characteristics subscreen; and
a filtering agent subscreen.

8. The method of claim 1 wherein the periodic financial schedule is generated monthly.

9. A computer-readable medium containing computer-executable instructions which, when executed, perform the method of claim 1.

10. A data structure, which when accessed, performs the method of claim 1.

11. An apparatus for calculating a cost associated with disposal of a substance, comprising:
an input module configured to accept a plurality of data inputs related to disposal of a radioactive substance;
a first computation module configured to generate a plant specification for a plant to dispose of the substance; and a second computation module configured to calculate a cost associated with the disposal of the substance.

12. The apparatus of claim 11 further comprising an output module configured to generate a utilization profile of the plant.

13. The apparatus of claim 11 further comprising an output module configured to generate periodic financial schedules for the plant.

14. The apparatus of claim 11 wherein the first computation module and the second computation module are the same.

15. A method for performing a financial analysis of a plant utilizing a treatment medium to filter a radioactive substance from at least one well, comprising:
accepting a plurality of data inputs related to the plant;
calculating a disposal cost of the treatment medium;
generating an income statement for the plant wherein the income statement is dependent, at least in part, upon the disposal cost of the treatment medium.

16. he method of claim 15 wherein the operation of calculating the disposal cost further comprises calculating the disposal cost of the treatment medium based, at least in part, on a starting location, a disposal location, and an acceptance fee associated with the disposal location.

17. The method of claim 16 wherein the operation of calculating the disposal cost of the treatment medium further comprises:
determining a transportation distance between the starting location and the disposal location;
determining an amount of treatment medium to be disposed;
determining a level of radioactivity of the amount of treatment medium to be disposed;
determining the acceptance fee based, at least in part, on the level of radioactivity;
determining a shipping fee based, at least in part, on the transportation distance; and
employing at least the acceptance fee and the shipping fee to calculate the disposal cost of the treatment medium.

18. The method of claim 17 wherein the disposal location is selected from the group comprising Grandview, Hanford, Newpark, and Yucca Mountain.

19. The method of claim 16 wherein the acceptance fee comprises:
a labor fee to accept the treatment medium;
a bagging fee to bag the treatment medium; and
a radioactivity fee determined by the level of radioactivity of the treatment medium.

20. The method of claim 17 further comprising:
performing the operation of calculating the disposal cost of the treatment medium for at least two disposal sites;
presenting the disposal cost for each of the at least two disposal sites.
